(19) United States
(12) Patent Application Publication
(10) Pub. No.: US 2012/0084170 A1
(43) Pub. Date: Apr. 5, 2012

(54) CUMULATIVE POINT SYSTEM AND SCORING OF AN EVENT BASED ON USER PARTICIPATION IN THE EVENT

(76) Inventors: Aaron J. Adair, Fairfield, CA (US); David L. Bauer, Lafayette, CA (US)

(21) Appl. No.: 12/895,412

(22) Filed: Sep. 30, 2010

(51) Int. Cl. G06Q 30/00

(52) U.S. Cl. 705/26.3

(57) ABSTRACT

An application controls an online auction event. A scoring heuristic generates scores based on user activity during the auction event. The scoring heuristic provides score information about each of a plurality of users participating in the auction event to the application during the auction event and the application provides the score information substantially simultaneously during the auction event to each of a plurality of computing devices for inclusion on a scoreboard display on a graphical user interface (GUI) of each computing device. The scoring information includes a first score for each user participating in the auction event that represents points awarded during the auction of one item in the event.

The auction event may include auctions of a plurality of items and the scoring heuristic maintains a second score for each user participating in the auction event that represents cumulative points awarded during the auction event.

### CROSS REFERENCE TO RELATED APPLICATIONS

The following cases, titled ONLINE AUCTION OPTIONALLY INCLUDING MULTIPLE SELLERS AND MULTIPLE AUCTIONEERS; AN INDICATION OF THE REMAINING DURATION OF AN EVENT WITH A DURATION RECOIL FEATURE; A CUMULATIVE POINT SYSTEM AND SCORING OF AN EVENT BASED ON USER PARTICIPATION IN THE EVENT; and AN OPTION FOR SUBMITTING A USER-DEFINED SUPER BID THAT OVERRIDES AN AUCTION COUNTDOWN, of which the present case is one, have all been filed on the same date. The contents of the three applications that have a different title than the present application are incorporated herein in their entirety.

### BRIEF DESCRIPTION OF THE DRAWINGS

FIG. 1 illustrates an exemplary online auction system with user access.

FIG. 2 illustrates an exemplary online auction system member web home page.

FIG. 3 illustrates an exemplary online auction system member list of items auctioned in a hosted auction.

FIG. 4 illustrates an exemplary online auction system auction creation web page.

FIG. 5 illustrates exemplary online auction system auction invitation options.

FIG. 6 illustrates an exemplary online auction system preview option prior to publishing an online auction.

FIG. 7 illustrates an exemplary online auction system option to join a live auction.

FIG. 8 illustrates an exemplary online auction system user interface display of a lobby prior to a live online auction.

FIG. 9 illustrates an exemplary online auction system user interface display during a live online auction.

FIG. 10 illustrates an exemplary flow diagram for determining part of the contents of a user interface display in a live online auction.

FIG. 11 illustrates an exemplary flow diagram for determining a change of the contents of a user interface display in a live online auction.

FIG. 12 illustrates an exemplary online auction system user interface display of a live online auction when an early bid was received.

FIG. 13A illustrates an exemplary online auction system user interface display of a countdown gauge.

FIG. 13B illustrates an exemplary online auction system user interface display of a countdown gauge near the end of a countdown.

FIG. 14A illustrates an exemplary online auction system user interface display of a bid area in a live online auction.

FIG. 14B illustrates an exemplary online auction system user interface display of a user-defined bid option in the bid area of a live online auction.

FIG. 15 illustrates an exemplary online auction system user interface display of auctioneer controls in a live online auction.

FIG. 16 illustrates an exemplary online auction system user interface display of auctioneer sub-controls in a live online auction.

FIG. 17 illustrates an exemplary online auction system user interface display during an intermission between sale items in a live online auction.

FIG. 18 illustrates an exemplary online auction system user interface display of a participant applause option in a live online auction.

FIG. 19 illustrates an exemplary online auction system post-live auction user interface display including an option to rate the auctioneers of the live auction.

FIG. 20A illustrates aspects of an exemplary online auction system user interface display for a handheld smart phone application.

FIG. 20B illustrates aspects of an exemplary online auction system user interface display for a handheld smart phone application.

FIG. 20C further illustrates aspects of an exemplary online auction system user interface display for a handheld smart phone application.

FIG. 20D further illustrates aspects of an exemplary online auction system user interface display for a handheld smart phone application.

### DETAILED DESCRIPTION

A physical auction is a social event. An auctioneer works to create an environment of excitement to encourage participation by more of the auction attendees and to encourage higher bidding. Excitement is also generated due to the competition among participants, who earn social status from actively participating in the auction. Excitement builds throughout the auction as the auctioneer sells an item and moves on to the next. In a well-planned and well-conducted auction event, attendees may consider the auction event to be a form of entertainment whether they are bidding or merely observing. Multiple sellers offering items in a single auction event may benefit from it being fun and exciting.

An electronic auction such as an online auction generally lacks the excitement of a physical auction because, among other things, there is not an auctioneer to stimulate or otherwise motivate the individuals that are present into action, a sense of participation in a social event, or social status earned by being recognized as contributor to the auction environment through active bidding. Thus, an online auction system is substantially improved by implementing excitement-generating features for the auction.

A further limitation of typical online auctions is that only a single item may be auctioned in each auction. The online auction system is thus further substantially improved by enabling an auction host to create an online auction including multiple items from multiple sellers.

For an exemplary online auction in an online auction system, such as one that follows the Timeline of Events below, an auction host may create and publish an online auction; users may participate in the auction by submitting early bidding and later joining an auction event in a lobby phase or a live auction phase; hosts, auctioneers, sellers, and buyers may perform post-sale activity; sellers and buyers may perform fulfillment of sold items; and the auction system may provide status reporting.

### Exemplary Timeline of Events:

| Create | Publish | Auction | | | Post-sale | Ful- | Re- |
|---|---|---|---|---|---|---|---|
| auction | auction | Early | Auction | | activity | fillment | ports |
| | | bidding | event | | | | |
| | | | Lobby | Live | | | |
| | | | | Auction | | | |

An auction host may access an online auction system website from a computing device remotely connected to the website through a network, using a graphical user interface (GUI). The auction host may prepare an auction, publish information regarding the auction, and invite people to an auction event. As used herein, the term “auction” is inclusive of both an auction event and the time prior to an auction event after the auction information is published, as illustrated in the exemplary Timeline above.

Invitees to an auction may browse the published auction information and participate in the auction event using a GUI on a computing device remotely connected to the website through a network. The published information may include a virtual gallery (Gallery) of the items to be auctioned. Invitees may view the Gallery and place pre-bids on one or more items in the Gallery. Pre-bids may be placed until the start of the auction event.

An auction event may include a virtual lobby (Lobby) and a Live Auction. For a predefined period before the start of the Live Auction, an invitee who chooses to participate in the auction event may, using the GUI, enter the Lobby and interact with other participants. Each participant may be displayed as a virtual representation, for example, as an icon or an avatar. A participant may interact with other participants in the Lobby by selecting his or her virtual representation and moving it within the Lobby space to simulate walking through the Lobby and approaching other participants. As a participant's visual representation nears the visual representation of another participant, the other participant's visual representation may change appearance to indicate proximity. Participants may communicate with each other while in the Lobby.

When the predefined period of the Lobby ends, the Live Auction may begin. The Live Auction may be a series of item auctions with an intermission after each item sale. The auction GUI may change at the beginning of the Live Auction to indicate auction information, for example, current high bid, highest bidders, current item for sale, etc. The GUI provides capability for entering incremental bids at increments predefined for the auction and may also include capability for entering a user-defined bid.

The Live Auction GUI may include a Gauge of the duration of the current item auction. At the start of an item auction, the duration is set to a predefined initial value, and the Gauge visually represents the initial duration value. As the auction progresses, the duration value decreases from the initial value and the Gauge visually depicts the remaining duration value. If a bid received during the auction is accepted as the current bid, the amount remaining in the duration value is increased and the Gauge is updated to reflect the increased duration value. When the duration value reaches zero, the auction for the current item is ended.

During the Live Auction an auctioneer may, among other actions, pause the auction event, interact with the auction participants during the auction event, eject a participant, and pass control of the auction to another auctioneer.

Participants, including the auctioneer and the auction host, may earn points based on amount and type of participation in the auction. Points may be cumulative across auctions. Participants may subjectively rate auctioneers and other participants based on behavior during the auction.

A seller may include an item for sale in the auction with a reserve amount such that if the reserve amount is not met during the auction then the item will not be considered to be sold. If at the end of the auction for the item the reserve is not met, the highest bidder may see the reserve price and may submit a counteroffer to the reserve price. The seller may then negotiate with the highest bidder for a mutually-agreeable sale price. In another implementation in which the auction host or auctioneer is different from the seller, the seller may set a minimum price, and the auction host or auctioneer may then negotiate with the highest bidder for a mutually-agreeable sale price greater than or equal to the seller's minimum price. Alternative to the bidder seeing a reserve price after the auction, the seller, auction host, or auctioneer may send a message to the highest bidder indicating that an offer less than the reserve price would be entertained and the highest bidder then has an option to make an offer.

Each item sold at the auction is then prepared and sent to the buyer by the seller of that item. Each buyer is presented with a report of the items the buyer won in the auction.

Having presented above an overview of an exemplary online auction system, details of such an online auction system are now provided.

### Online Auction System

The term “online auction system” is to be broadly interpreted as a combination of hardware components and software components collaborating to provide over a network services related to an auction.

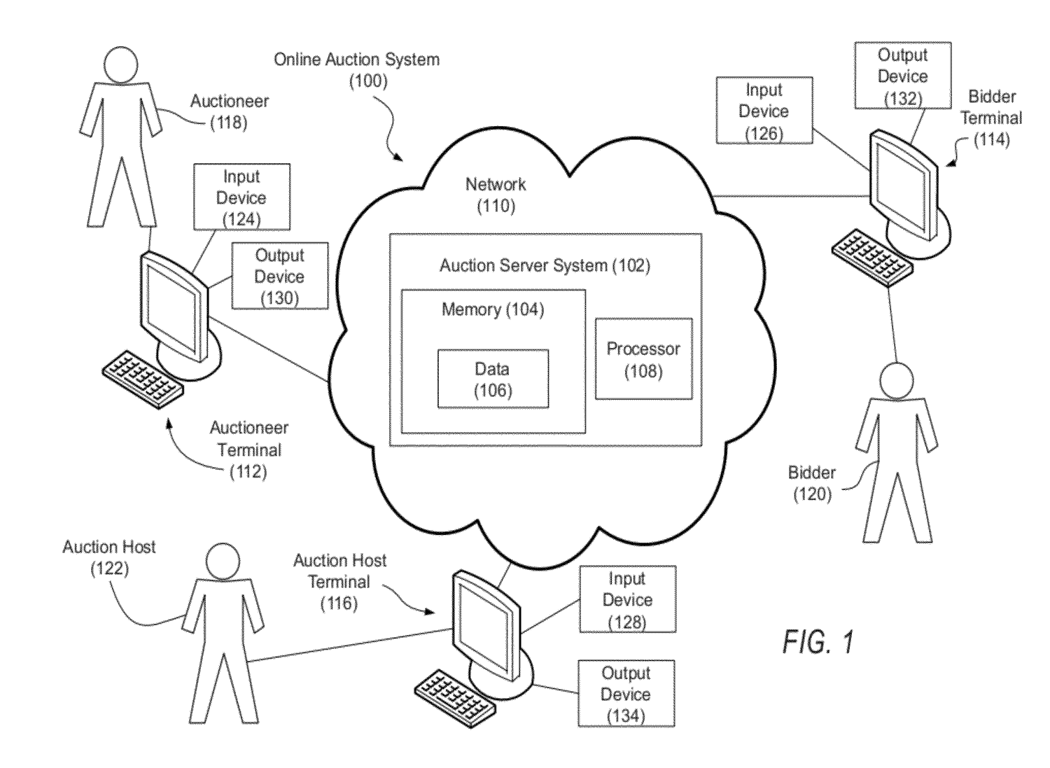

FIG. 1 is a diagram showing an illustrative setup for an online auction system 100. The online auction system may include an auction server system 102 which includes a processor 108 and a memory 104 having auction data 106 stored thereon. The auction server system 102 may be accessible over a network 110 through a number of terminals 112, 114, 116. A terminal 112, 114, 116 may be, for example, a desktop computer, a laptop computer, a mobile phone, a personal digital assistant PDA, or a smart phone. An auctioneer 118 may access system 100 through an auctioneer terminal 112, a number of bidders 120 may access system 100 through bidder terminals 114, and an auction host 122 may access system 100 through an auction host terminal 116. It should be noted that at different times during a user's use of system 100, the user's role may change depending on what type of activity the user is engaged in at a particular time. Thus, any terminal 112, 114, 116 may potentially be used for access by an auctioneer 118, bidders 120, or auction host 122. Further, although not shown in FIG. 1, users other than auctioneer 118, bidders 120, and auction host 122 may also access the auction server system 102 through a terminal such as terminal 112, 114, 116.

An auction server system 102 may be embodied as one or more application servers. An application server is a framework of hardware and software dedicated to executing scripts, programs, and routines associated with the construction of a computer application. Application servers are often used to provide web applications. In such applications, a user may use a web browser stored on a local terminal to access the application which is processed by the application server. For example, if a user wishes to use a particular web application, the user may use a web browser installed on his or her local machine and enter in a specific network address. The browser is then configured to interact with the application server via a network such as the Internet and present to the user elements associated with the web application.

Application servers typically make use of various types of memory 104. Many types of memory 104 exist and may be used in conjunction with auction server system 102. Some types of memory 104, such as hard disk drives, optical disc drives, solid state drives, and other nonvolatile memory, are optimized for storage. An application server may make use of one or more storage servers. A storage server is a framework of hardware dedicated to storing electronic data. Other types of memory, including volatile memory such as Random Access Memory RAM, are optimized for speed and can be used as “working memory” for providing executable instructions to a processor 108. The various forms of memory 104 may store information in the form of both data 106 and software. In certain implementations, memory 104 includes both nonvolatile and volatile memory.

Memory 104 may be configured to hold various types of data 106 for auction server system 102. Data 106 may include a variety of information associated with the several auctions which are executed over the system. For example, auction item data, auctioneer 118 data, auction host 122 data, bidder 120 data, and other participant data may all be stored on the memory associated with auction server system 102.

A user may further interact with online auction system 100 through an input device 124, 126, 128 or output device 130, 132, 134 associated with the user's terminal 112, 114, 116. Input 124, 126, 128 and output 130, 132, 134 devices allow a user to participate in an auction event and communicate with others using system 100, for example through the use of Voice over Internet Protocol VoIP or other voice transfer protocol.

In some exemplary implementations, a user downloads an auction application to be processed by his or her local terminal 112, 114, 116. In such an implementation, the locally run auction application may be configured to enable a user to interact with online auction system 100.

As mentioned, an auction includes, in addition to an auction event, publication of information regarding the auction event and access to the auction event information. Users interacting with online auction system 100 may become participants in an auction event by selecting a published auction to which they are invited.

### Auction Event Participants

A participant of an auction event is any user that attends the auction event. A user who is a participant (Participant) may also be categorized for one auction event as one or more of auction host 122, auctioneer 118, or bidder 120. A bidder 120 is a Participant that either submitted a pre-bid for an item scheduled to be for sale in the auction event before the auction event began or that submits a bid on an item for sale during the Live Auction. Participants are not required to become bidders 120.

Any Participant in an auction event may also be a seller of one or more item in the auction, although the auction application may block a seller from bidding on an item the seller is selling. There may be one or more seller of one or more item to be auctioned during the auction event. A seller of an item in an auction need not be a Participant in the auction event and need not even be a user of online auction system 100.

A seller in an auction is someone who offers an item for sale. The term “sale” is meant to be understood as any disposition of property in exchange for some form of compensation. The types of transactions which may be considered a “sale” may include, but are not limited to, disposition of property via an auction, a consignment sale, bartering through exchange of goods or services for other goods or services, a trade, or offering services in exchange for compensation. Compensation may be, for example, in terms of currency, credit, goods, and securities. The concept of a sale further includes non-traditional services and compensation, such as “paying” in hugs or “selling” pats on the back.

An auction host 122 defines an auction event, publishes information regarding the auction event and the items to be auctioned, and invites people to the auction. Definition, publication, and invitations for the auction are discussed in detail below. An auction host 122 may also be a seller, a bidder 120, an auctioneer 118, or other Participant in the auction. An auction host 122 that is a seller of an item may not also be a bidder 120 on the same item. Thus, in an implementation in which the auction host 122 is the same person as the seller, the auction host 122 may not be a bidder 120. The auction host 122 may be considered a Participant even if not actually participating in the auction event.

One or more auctioneers 118 conduct the auction event. During auction definition auction host 122 may identify a person or persons to take the role of auctioneer 118. Auction host 122 may either receive permission to identify the person as an auctioneer 118 outside of online auction system 100 or may issue a request to the person as part of the auction invitation process. An auctioneer 118 may also be a seller. An auctioneer 118 may not be a bidder 120 on any item auctioneer 118 is auctioning. During an auction event, generally during an intermission time between item auctions, the auction host 122 may make a request to a Participant of the auction to take control of the auction and become auctioneer 118. The Participant may reject the request. If the Participant accepts the request, once control has passed to the Participant, the previous auctioneer 118 becomes a Participant and may become a bidder 120. In an alternative implementation, during an auction event an auctioneer 118 may request another Participant of the auction, who may be one of auctioneers 118 identified by auction host 122 during auction creation, to take control of the auction and become auctioneer 118. The other Participant may reject the request. However, if the other Participant accepts the request and current auctioneer 118 successfully passes control of the auction to that Participant, then current auctioneer 118 becomes a Participant and may become a bidder 120.

As mentioned above, an auction Participant may assume multiple roles within the same auction event. Some examples of multiple roles include: the roles of auction host 122 and auctioneer 118 may be performed by the same person who may also be the seller of one or more items; a person may be a bidder 120 for one item and an auctioneer 118 for another item; any Participant in the auction event may also be a seller of one or more item in the auction; and auction host 122 may also be a bidder 120. In some implementations, Participants may be limited to single roles. For example, an auctioneer 118 may be prevented from bidding in an auction event even when not in control of the current item auction. For another example, the auction host 122 may be prevented from bidding in the auction event.

### Online Auction System User Interface

A user of online auction system 100 is presented with a home page for browsing the available public auctions.

A visiting user's home page may include information regarding popular auctions and a search option for finding auctions by category or by, for example, auction host 122 or auctioneer 118.

A visiting user may join online auction system 100 and become a member. Joining an auction includes at least entering identifying information and potentially one or more payment options. Members may, among other things, customize their home pages, enter bids, join auctions, be an auctioneer 118, and host auctions. Members may also send and receive messages to/from other members, and view the sent and received messages on their home pages. System 100 may provide many other options to members in addition to those described.

A member's home page may include a browse tab, a bid tab, and if applicable, auctioneer or auction host tabs. In one implementation, the browse and bid tabs are combined into one tab. More tabs may be added as desired to organize the information on the home page.

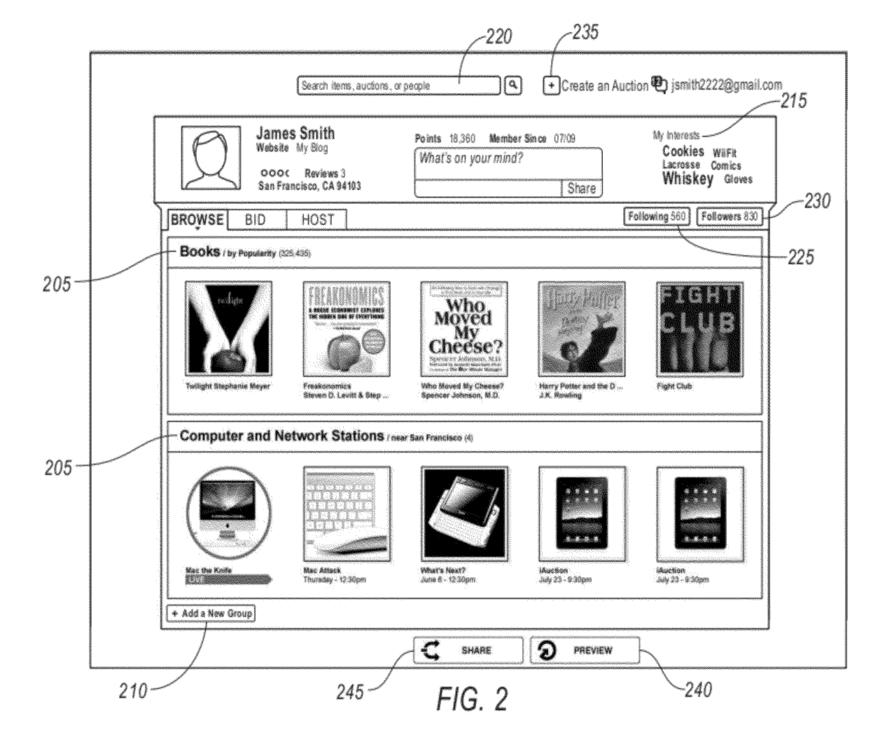

FIG. 2 illustrates an exemplary browse tab on a member home page which includes among other things groups of results of searches performed 205; an option 210 to add a new group; an area showing the member's interests 215; a search field 220 to search for an item, auction or person by entering a search term; a drop-down list 225 of members being followed and a list of members who are followers 230; an auction creation option 235; and an auction preview option 240. The browse tab of FIG. 2 is merely exemplary to illustrate some of the many options that may be included on a browse tab. It should be understood that the browse tab illustrated in FIG. 2 is not limiting, and a member browse tab may include more or fewer options, and the options may be presented in alternate ways.

Examples of further options that may be displayed on a member browse page include auctions invited to, auctions being watched, favorite categories, and an option to write reviews of other members.

A member's home page may be visible to other members unless the page or portions of the page are marked as private. The member has the option to change the privacy settings. Returning to the example of FIG. 2, the member may, for example, select a “share” option 245 to configure privacy settings.

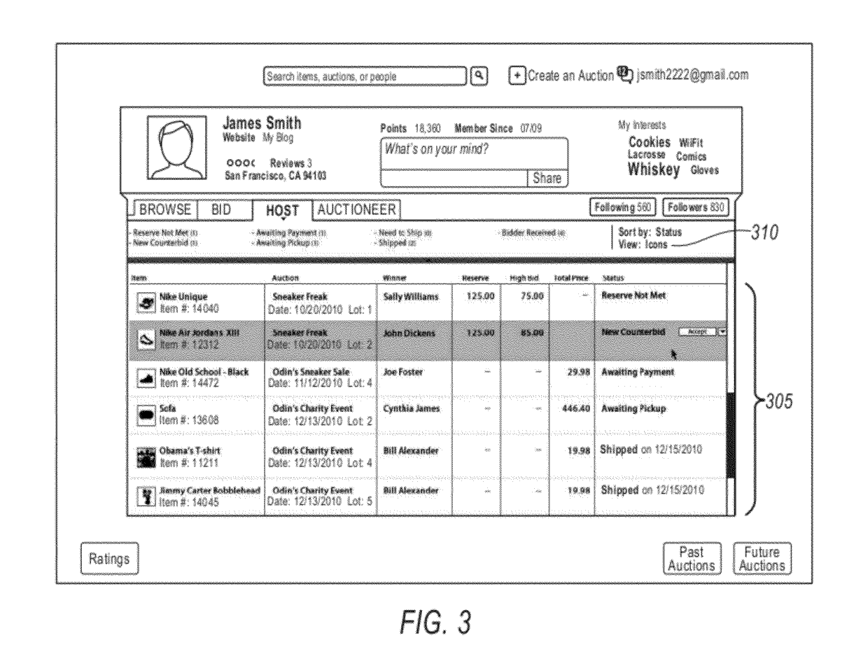

FIG. 3 illustrates an exemplary auction host tab on the member home page. Information on a host tab may include the auction status of the items auctioned, such as reserve not met, sold, and sold in post-auction; the fulfillment status of the items sold, such as paid, shipped, and received; and the preview status of items to be sold, such as starting price and pre-bids received. The display may be selectively in icon view or list view. The illustration in FIG. 3 includes a list 305 view of items auctioned sorted by status, wherein status includes auction status and fulfillment status. FIG. 3 also illustrates an option 310 to switch from a list view to an icon view of the items. It should be understood that the host tab illustrated in FIG. 3 is not limiting, and a member host tab may include more or fewer options, and the options may be presented in alternate ways.

FIG. 3 illustrates, in addition to the browse and host tabs described, a bid tab and an auctioneer tab. A bid tab on the member home page may include information on bids placed, and may provide options for placing bids. As mentioned above, the bid tab and the browse tab may be combined into one tab in an implementation. An auctioneer tab on the member home page may include information on past and future auctions in which the member was or will be an auctioneer 118.

Any user at any time may report a concern to online auction system 100, for example, a concern that an item is a counterfeit, violates a copyright, is prohibited, is offensive, is stolen, or other concern. A member home page may include an option to report a concern.

### Auction Creation

As mentioned, auction host 122 is a user that creates an auction and publishes the auction information. Auction host 122 accesses his or her member home page in online auction system 100 to customize a default auction template. In some implementations, a user must pay a fee into online auction system 100 to create an auction. An auction may be a forward or reverse auction. A forward auction strives to achieve the highest price, and is used, for example, for selling individual items, item lots, or services. A reverse auction strives to achieve the lowest price, and is used, for example, for procuring services such as design or manufacturing at a minimum price. The examples herein describe forward auctions, but the concepts apply equally to reverse auctions. The auction host 122 may identify the auction as a forward or reverse auction by, for example, selecting the applicable option in an auction template or by selecting the appropriate auction template.

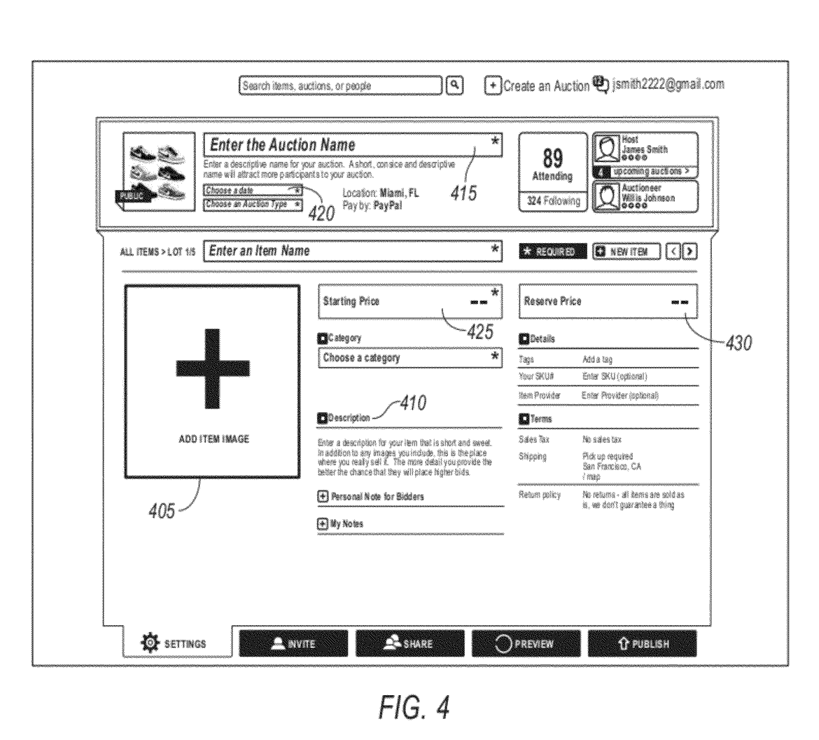

FIG. 4 illustrates an exemplary auction template. An auction template provides among other things options to input audiovisual information for the items to be auctioned. Audiovisual information includes but is not limited to photographs, video clips, drawings, and text. In the example of FIG. 4, audiovisual information may be added by selecting an “add item image” area 405 and a description 410. Other auction template options illustrated in FIG. 4 are options for naming the auction 415, setting the event date 420 and time, and selecting starting 425 and reserve 430 prices. Auction template options not illustrated in FIG. 4 may include identifying the order of the auction and selecting acceptable methods of payment and fulfillment, among other things. An auction may be copied as a starting point for creating further auctions.

Auction host 122 may further select persons to invite to the auction. If invitation capability is provided within the auction template, invitees may be entered into the auction template directly or may be selected from a contact list. For example, any contact list available on terminal 112, 114, 116 such as contact lists for email or for social networking sites may be accessed and individuals may then be selected from the contact lists as invitees.

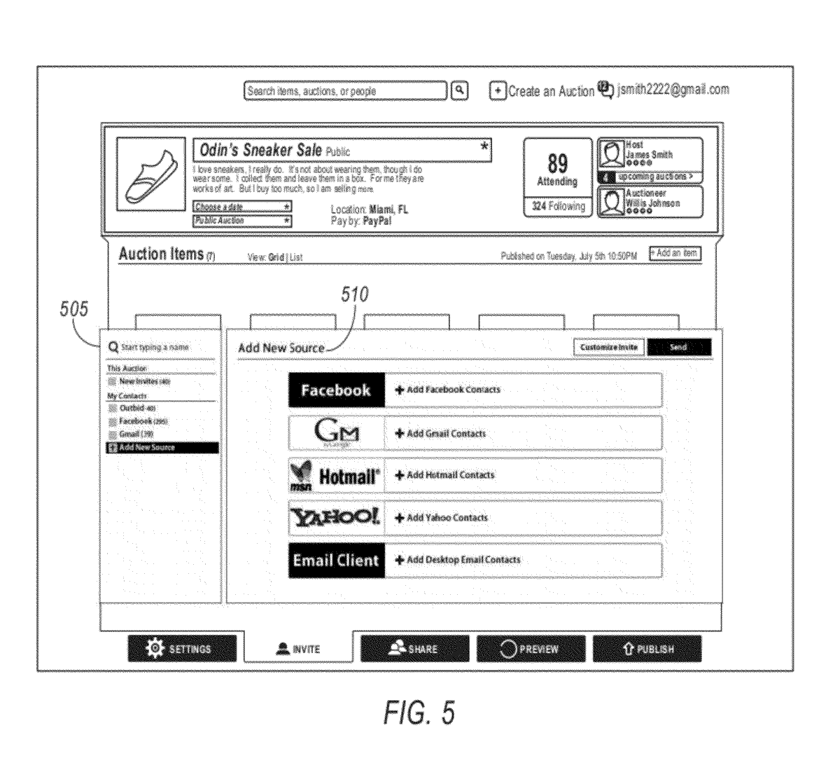

FIG. 5 illustrates exemplary options 505 for adding contacts or contact lists from available sources and an option 510 for adding a new source. The auction host may further select to share the auction on a social network, such as by creating a page in the Facebook application from Facebook, Inc. Alternatively to creating an invitee list within the auction template, auction host 122 may make invitations after publication of the auction. Auction host 122 may alternatively set the auction as public in which case no invitations are necessary.

Items to be auctioned may be categorized and sub-categorized to allow for searching within and between auctions. For example, an item may be categorized as personal goods, then sub-categorized in a hierarchical structure such as [clothing[sport[shoe[running[Nike]]]]]. After a user finds an item in a sub-category, the user may then have the option for searching the sub-category for similar items. For example, if [clothing[sport[shoe[running]]]] was a first sub-category searched for [Nike], then a user may select to see all items in sub-category [clothing[sport[shoe[running]]]] and not just [Nike] items. The user may also have the option to search only within the same auction, or across all private auctions to which the user is invited and/or across all public auctions.

An auction may include keywords to further enable searching, such as “moving sale” or “collectibles.”

When auction host 122 has completed configuring the auction, auction host 122 may then publish the auction. Prior to publication, auction host 122 may wish to preview the display of the auction.

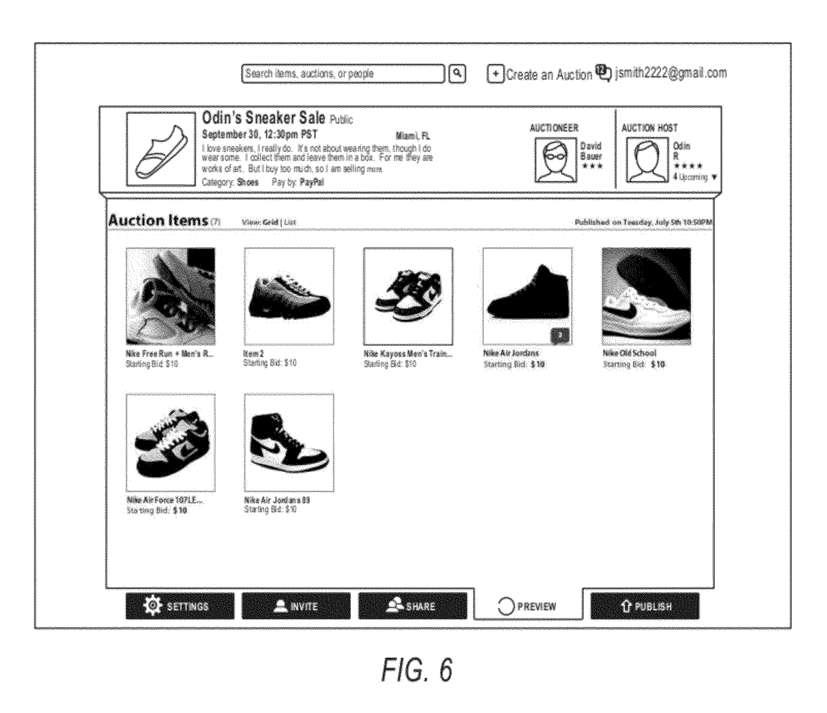

FIG. 6. illustrates an exemplary auction in preview mode ready to publish. Auction host 122 selects the preview pane to view the auction in the manner it will be displayed to other users after publication.

Note that in the example of FIGS. 4 and 5 member James Smith was creating the auction with himself designated as auction host 122 but in FIG. 6 auction host 122 is designated as Odin R. This difference illustrates an optional capability of system 100, in that a member may create and publish an auction for another person. For example, Odin R may not have the technical ability or time to create and publish an auction but still wants to host an auction, and therefore asks James Smith to create and publish with Odin R listed as auction host 122. After publication, Odin R would have all responsibilities associated with the role of auction host 122, such as coordinating sellers, answering user questions, and verifying that fulfillment obligations are met. Although this option may exist in system 100, the auction creator will nevertheless be referred to as auction host 122 hereinafter to simplify the following discussions, with the understanding that auction creator and auction host 122 may actually be different people.

Another point to note is that James Smith designated Willis Johnson as auctioneer 118 in FIG. 4, but changed the designation to David Bauer at some time before selecting the preview option illustrated in FIG. 6. On a larger scale, auction host 122 may change many details of an auction before publication.

### Auction Publication

A member may publish an auction by selecting the publish option on the member home page in online auction system 100. In some implementations, a user must pay a fee into online auction system 100 to publish an auction. Until the auction is published, the auction is not accessible to any user other than auction host 122. After publication, a private auction is accessible only to invitees of the auction; however, any user may access a public published auction.

After the auction is published, the auction host 122 may cancel the auction. In this case, the auction is unpublished and canceled, and pre-bidders are released from their obligations on pre-bids placed. The auction host 122 may then edit the auction and re-publish it as a new auction. In one implementation, auction host 122 may edit an auction without canceling by accessing the published auction through the host's member home page. Edits may include adding or deleting items for sale, changing starting or reserve prices, adding or deleting audiovisual information, changing the sale order of the items to be auctioned, converting from a private to a public auction or vice-versa, adding or deleting invitees, etc. In such an implementation, the online system 100 may release pre-bidders on their obligations on pre-bids placed when a published auction is edited.

If auction host 122 cancels or edits the auction after receiving a response (RSVP) from an invitee, online auction system 100 may notify the invitee that auction host 122 made edits to the auction, and may further provide details of the edits to the invitee. In one implementation, online auction system 100 notifies only pre-bidders that the auction was edited or canceled, and may not provide details of edits.

As mentioned above, a user may search for auctions on the online auction system 100. For example, a user may search by one or more of auction host 122, auctioneer 118, auction invitee, category or sub-category, keyword, and date. The user may select to conduct the search across all public auctions and/or all private auctions to which the user has been invited. The user may alternatively view a scrollable list of all private auctions to which the user has been invited, all public auctions, or all auctions.

From an auction list, the user may select an auction to view. Viewing the auction includes viewing, for example, the date and time of the auction, a countdown to the auction, information about the invitees or the invitees that have submitted an RSVP, information about auctioneer 118, and information about the items for sale in the auction. The items for sale may be arranged in a Gallery, accessed from a link on the web page.

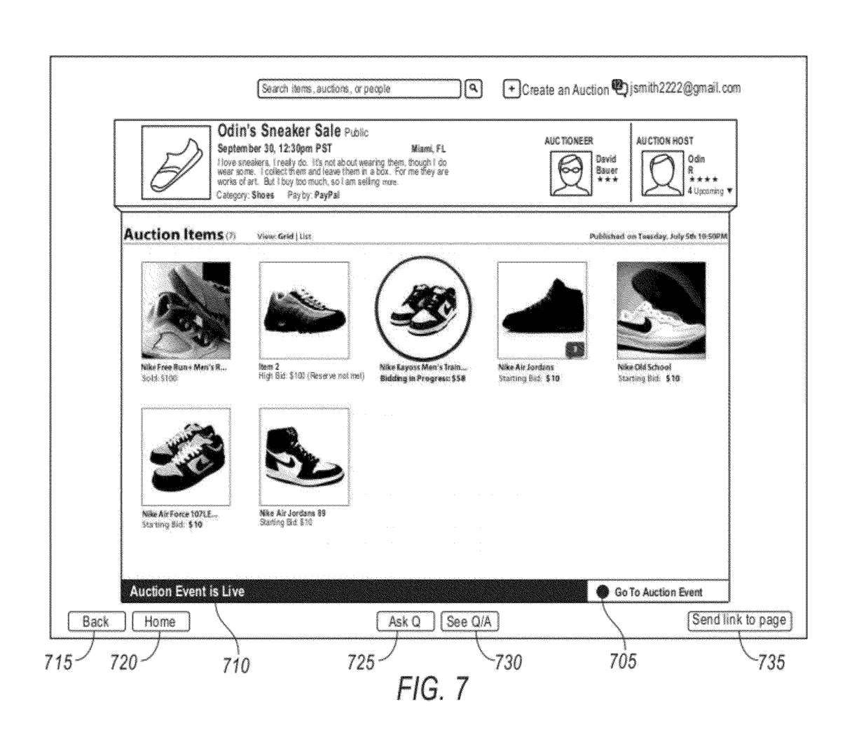

FIG. 7 illustrates an exemplary Gallery of an auction with the option 705 to join a current auction event. In this example, the display shows that the auction is in the auction event phase by the indication 710 that the “Auction Event is Live”.

A user may ask auction host 122 questions and auction host 122 may respond, and may also post the question and the response on the auction page. Users may view the posted questions and responses. In FIG. 7, for example, there is an option 725 for viewing an area for asking question and an option 730 for viewing a list of posted questions and answers.

A user may be offered many options while viewing a Gallery. Some examples include, as shown in FIG. 7, an option 715 to return to the previously-viewed display screen, an option 720 to return to the user's home page, and an option to send a link to the Gallery to another user of system 100 or to another destination. There may be many more options available in the Gallery, not limited to those described.

### Early Bidding

A user may place a pre-bid on an item or items in the Gallery by entering a dollar amount into a data entry area on the auction web page. Later users may be able to see that there is a pre-bid and may additionally be able to see the amount of the pre-bid, and may place their own pre-bids if they so choose. The highest pre-bid is carried forward as the starting price in the Live Auction. Pre-bidding is allowed until the auction event begins.

In some implementations, a user must pay a fee into online auction system 100 to place a pre-bid.

### The Auction Event—The Lobby

As noted above, an auction event may begin with a Lobby phase followed by a Live Auction phase. The Lobby at the auction event opens starting at a predefined time before the Live Auction is scheduled to begin. Online auction system 100 may provide an option for setting the Lobby start time and Live Auction start time separately or set one start time and set the other time relatively. Alternatively, online auction system 100 may allow for setting one of the Lobby or the Live Auction start times, with the duration of the Lobby phase being predefined by system 100.

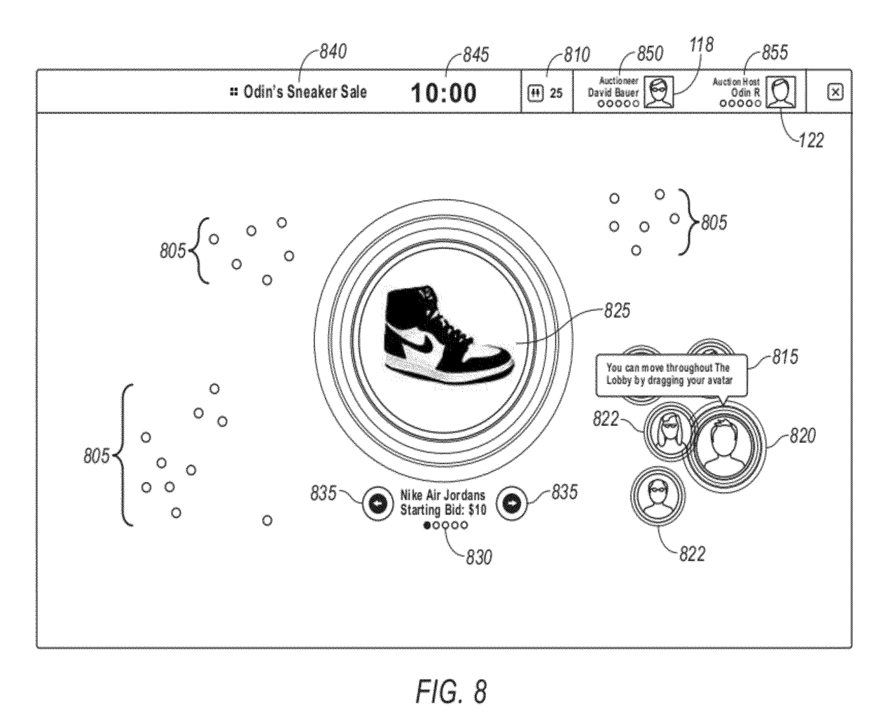

FIG. 8 illustrates an exemplary implementation of a Lobby. A user may access the Lobby of an auction from the user's home page. In some implementations, a user must pay a fee into online auction system 100 to enter an auction Lobby. Online auction system 100 may limit access to auction events, including access to the Lobby, to members.

Some examples for selecting to join an auction are double-clicking on the icon representing the auction, right-clicking the icon and selecting the appropriate link, or selecting the auction icon and then selecting a “join” option. Each user in the Lobby is visually depicted in some manner, and the depiction may change depending on user interaction within the Lobby, as discussed below. In the example of FIG. 8, the users present are initially depicted to the user entering the Lobby as dots 805 on the page.

In the example of FIG. 8, the number of users present in the Lobby is indicated 810 on the Lobby display. A user may select to view a list of the users present, for example by clicking on the indication of the number of users and seeing a drop-down box with a list of names. The user may further select a user from the list of users present, and the visual representation of the selected user on the Lobby display may then be highlighted in some manner. Highlighting examples include the visual representation being enlarged, changing color, changing from a dot to an avatar, or having an arrow pointed at the user indicator. The user may select the visual representation of any Participant in the Lobby to see information regarding that user, such as name, score, rating, and picture. Scores and ratings are discussed below in detail. Other information about a selected user may also be presented, such as geographical location or relationship to auction host 122. For example, if the auction is private and the invitees are relatives, user information may include the user's generation and the user's parents. As another example, if the auction is private and the invitees are all suppliers, the user information may include the company represented by the user.

The ability to view information regarding users in the Lobby may be limited to those users who have taken a further step to “enter” the Lobby. A user may enter the Lobby by selecting his or her visual representation, for example by clicking on the user's avatar. A user may “move” around the Lobby by selecting his or her visual representation and dragging it around the page. In the example of FIG. 8, note 815 adjacent to the highlighted visual representation 820 of a user who has entered the Lobby instructs the user how to “move” around the Lobby. As a user moves around and approaches other users (i.e., the visual representations of the users are close to each other on the Lobby display), the visual representations of the proximate users may be enlarged and/or modified. The example of FIG. 8 illustrates the dots representing other users enlarging and changing to photographs 822 of the other users. As another example, the dots representing other users may enlarge and change to text identifiers of the users, and may include information such as name and score. “Name” as used within this document includes alias. Online auction system 100 may, however, require the use of actual names and prevent the use of aliases.

When users are proximate each other, they may be provided the ability to communicate with each other. Communication may be through live text entered at a terminal 112, 114, 116, live audio or live video possibly accompanied by live audio exchanged through input devices 124 and output devices 130 at user terminals 112, 114, 116, and/or some other form of communication. Some examples of other forms of communication may include transferring files, links, emoticons (icons that depict emotion), bar codes, or tactile messages such as a vibration command for a smart phone.

Audio communication between users may be at a higher volume when the users are closer and at a lowering volume as the users move away from each other. In this way, the users may experience the feeling of moving around and joining conversations in the Lobby to enhance the sense of the Lobby as a social event. The visual representation 822 of a user may enlarge or otherwise change appearance when the user is communicating, to provide focus on the communicating user and further enhance the feeling of being present in a social event.

Auctioneer 118 may communicate with any user present in the Lobby, and may also broadcast a message to the Lobby area to be received by all users present.

Each user in the Lobby may view the items to be sold in the Live Auction. Upon entering the Lobby, a user may be presented with the first item to be auctioned and may choose to see different views of that item or to see other items in the auction. In FIG. 8, an item is shown displayed at the center 825 of a circle. Users may see other views of this item by selecting from view numbers under the item or as illustrated in FIG. 8, by selecting one of the circles 830 representing alternate views of the item. The user may see other items in the auction by selecting “+” or “−” buttons to scroll through the items, or as illustrated in FIG. 8, by selecting arrow buttons 835. Users in proximity with each other in the Lobby may communicate to identify which item number they wish to discuss, if available, and each user then individually may use scroll buttons to find that item.

In another implementation, some or all of the items to be auctioned may be displayed around the Lobby and users may congregate around an item and discuss that item.

At any time a user may elect to view the auction Gallery for more information regarding the items for sale, including pre-bids already placed and starting prices for the items. However, as mentioned above, the auction may be closed to bidding once the Lobby phase of the auction begins. The Lobby may include a link to the Gallery, or the user may open a new browser window or tab and access the Gallery through the online auction system 100 web site.

The Lobby may include visual representations of auction host 122 and the first auctioneer, with name, score and/or rating. Scoring and rating are discussed below in detail. The Lobby may also include the name of the auction as defined by auction host 122 during auction creation. The Lobby may include a countdown indicator to notify the users in the Lobby how long it will be until the Live Auction begins. The countdown indicator may count down with varying resolution. For example, the countdown indicator may count down in increments of minutes at the beginning of the Lobby phase and then count down in seconds during the last minute before the Live Auction begins. As another example, the indicator may indicate both minutes and seconds throughout the duration of the Lobby phase.

FIG. 8 illustrates examples of displays of an auction name 840, lobby countdown indicator 845, auctioneer identifier area 850, and auction host identifier area 855.

The auction event may be paused during the Lobby phase by auction host 122 or by the first auctioneer 118. For example, auction host 122 may pause the Lobby if expecting more attendees or if answering questions. When the Lobby phase is paused, the countdown indicator stops counting down. When the Lobby phase resumes, the countdown indicator resumes counting down where it stopped. Online auction system 100 may limit the number of pauses available in an auction event, and may limit the length of a pause.

After the predefined Lobby period has expired, the Live Auction phase of the auction event begins. In an alternative implementation, the auction host 122 or auctioneer 118 may start the Live Auction at any time during the Lobby phase.

### The Auction Event—The Live Auction

Users who enter the auction event during the Lobby phase automatically enter the Live Auction phase when it begins. If a user does not enter the auction event during the Lobby phase, the user may enter the Live Auction phase directly by selecting the auction from the online auction system 100 web page, for example by double clicking on the auction icon. In some implementations, a user must pay a fee into online auction system 100 to participate and/or to bid in a Live Auction.

Any user present in the Live Auction is a Participant of the Live Auction. A Participant may further be acting in the role of auction host 122 or auctioneer 118, and may enter the Live Auction as a bidder 120 that placed a pre-bid. During the Live Auction, any Participant may become a bidder 120 by placing a bid, except that an auctioneer 118 may not bid on an item while he or she is auctioneer 118 of that item and a seller may not bid on any item the seller is selling. The online auction system 100 may prevent additional Participants from bidding. For example, the auction host 122 may be prevented from bidding on any item.

Online auction system 100 may present a standard Live Auction display that a user sees when entering an auction event during the Live Auction phase. Alternatively, if system 100 provides display configuration capability during auction creation, the Live Auction display may appear as personalized by auction host 122.

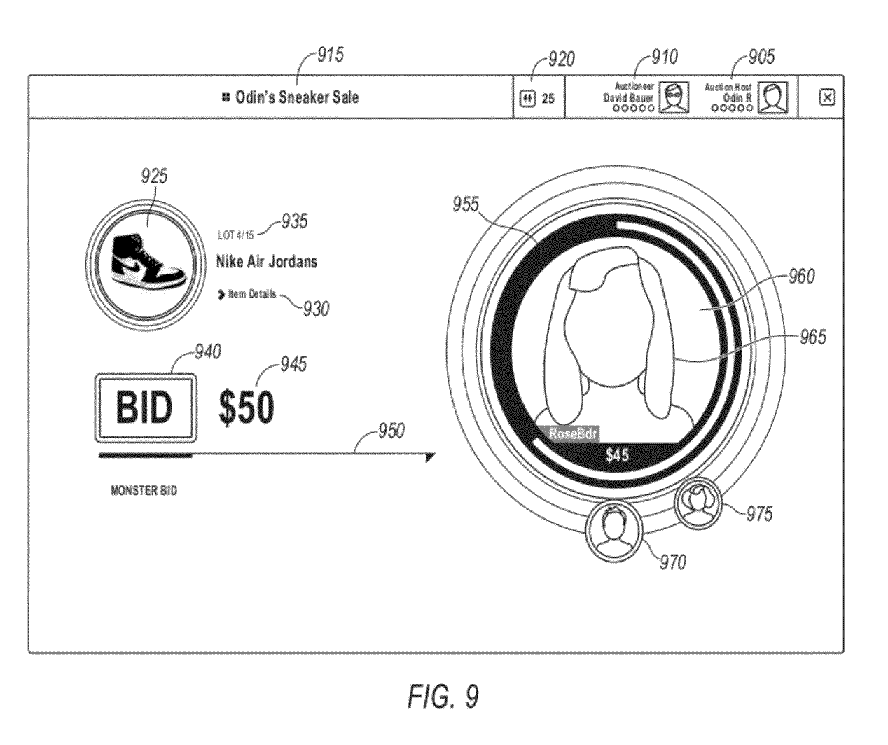

FIG. 9 illustrates an exemplary display of a Live Auction including identification of both auction host 122 and auctioneer 118 separately, 905 and 910 respectively, where both host 122 and auctioneer 118 are identified by name and by visual representation. The rating of each of host 122 and auctioneer 118 are also displayed in FIG. 9. A score, not shown in FIG. 9, may be displayed and updated dynamically to indicate a number of points earned by host 122 and auctioneer 118 in the current Live Auction or current item auction, and another score cumulative across all auctions may further be displayed. Scoring and rating are discussed in detail below. The host 122 and auctioneer 118 identification areas may include other information, such as familial relationship to others in the Live Auction, or identification of corporate affiliation. The information provided with respect to host 122 and auctioneer 118 may be identical to or different from the information displayed during the Lobby phase.

As illustrated in the example of FIG. 9, the Live Auction display may include the name of the auction 915 as defined by auction host 122 during auction creation, and an indication 920 of the number of Participants in the Live Auction. In some implementations, a user may select the indication of the number of Participants to view a listing of the names and other information of the Participants. In some implementations, Participants may interact with other Participants, as was described above with respect to users present in the Lobby.

As also illustrated in the example of FIG. 9, the Live Auction display may include a visual representation 925 of the item currently being auctioned, a selection option 930 to view more information about the item, and a selection option 935 to view other items in the auction. At any time a user may also elect to view the auction Gallery for more information regarding the items for sale, including pre-bids already placed and starting bids for the items. The user may open a new browser window or tab and access the Gallery through the online auction system 100 web site, or the Live Auction display may include a link to the Gallery. During a Live Auction, the information as previously available in the Gallery as discussed above is still available as applicable, and additionally the items in the Gallery are identified according to their status in the Live Auction. For example, an item may be marked as Sold, Skipped, In Auction, Coming Up, You Won, or the like. Information such as sold price or reserve price met may also be displayed with the item. An example of a Gallery was illustrated in FIG. 7.

The Live Auction display includes a bid entry area and a countdown gauge (Gauge). In the example of FIG. 9, the bid entry area includes the button 940, bid value 945, and Monster Bid bar 950, and the Gauge is shown as a ring 955. Bidding and the Gauge are described below in detail. The Live Auction display further includes a showcase area (Showcase) that may change contents depending on the pre-bid activity before the auction event began and further depending on the progression of the Live Auction. In the example of FIG. 9, Showcase 960 includes a display 965 of the highest bidder 120. Displays of the next two highest bidders 120 are shown in a first position 970 adjacent to the display and a second position 975 adjacent to the display. Showcase 960 is described in more detail below. A Live Auction display may include additional components or fewer components than mentioned above.

Auctioneer 118 has several options during the Live Auction to control the progression of the auction. Auctioneer Controls are discussed below in detail.

### The Showcase

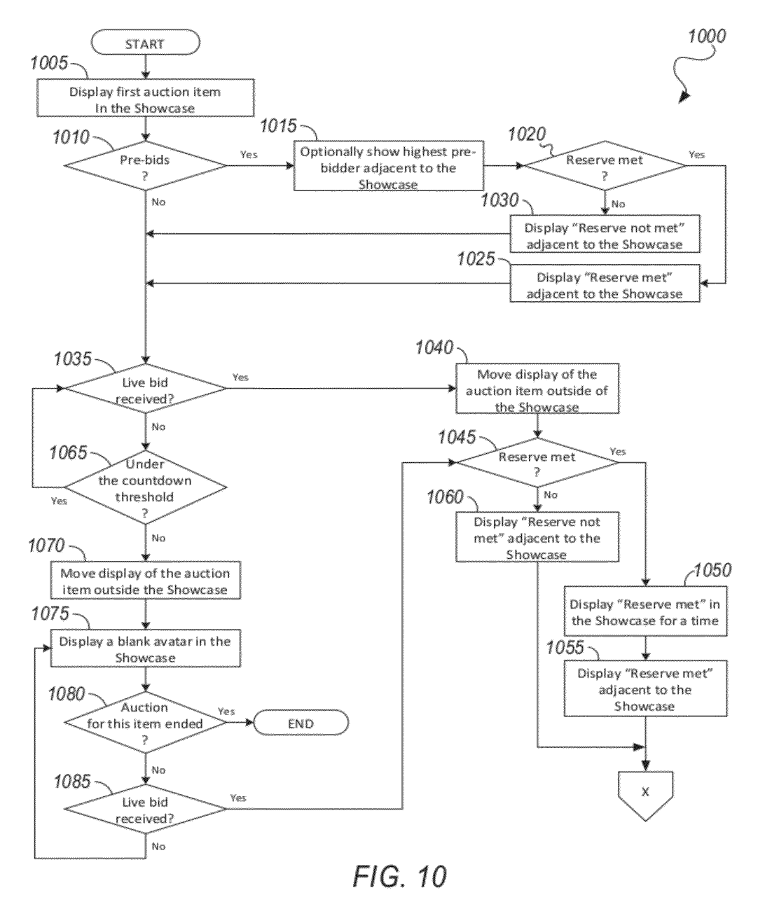

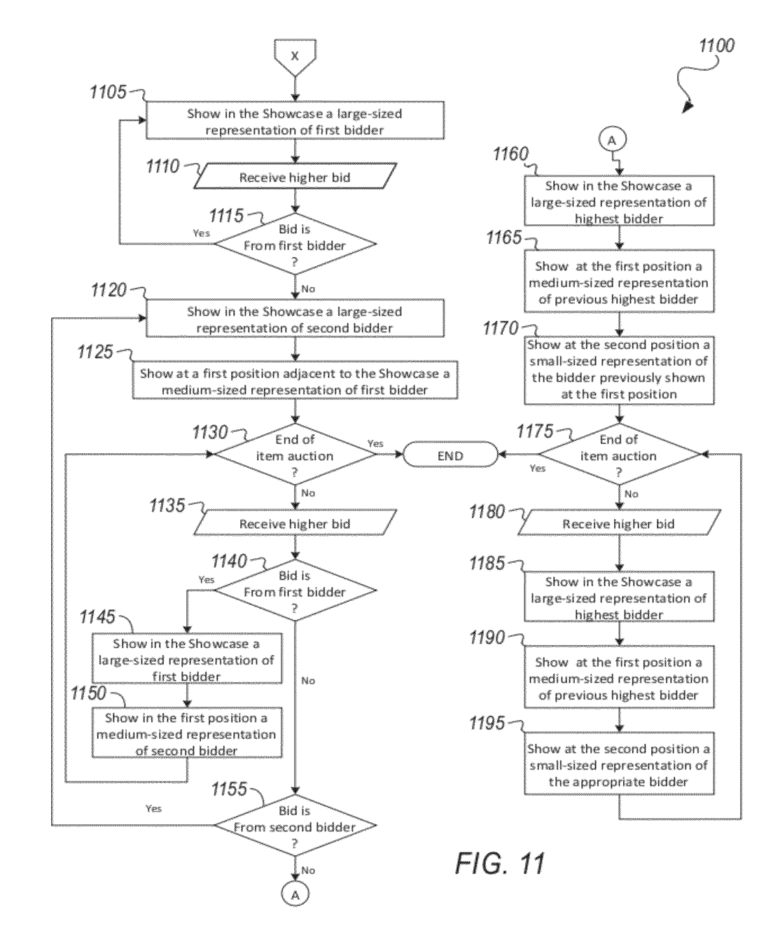

As mentioned above, the Showcase varies depending on the progression of the Live Auction. Examples of how the Showcase may vary are described with reference to the flow diagrams of FIGS. 10 and 11. FIG. 10 flows into FIG. 11 at connector X. FIG. 10 illustrates how the Showcase may vary starting at the beginning of an item auction. FIG. 11 illustrates how the Showcase may vary after the first live bid is placed. A live bid is a user bid placed from a terminal 112, 114, 116 after the Live Auction phase begins.

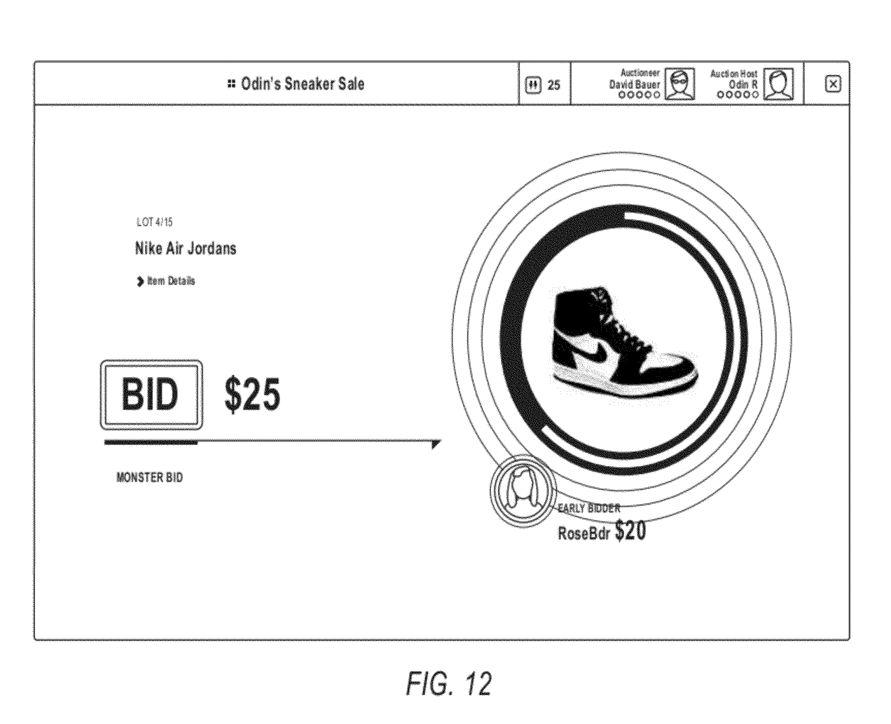

In FIG. 10, an exemplary process 1000 begins at 1005 at the start of an item auction, with the item displayed in the Showcase. At 1010, if pre-bids were placed before the auction event began, meaning before the beginning of the Lobby phase, then process 1000 continues at 1015 where a visual representation of the bidder 120 who placed the highest pre-bid is optionally shown adjacent to the Showcase, as illustrated in the example of FIG. 12. The process continues at 1020 for a determination of whether the reserve value for the item was met by the highest pre-bid. If the reserve value was met, at 1025 “Reserve Met” or the like is added to the display in or adjacent to the Showcase. If the reserve value was not met, at 1030 “Reserve Not Met” or the like is added to the display in or adjacent to the Showcase. In either case, process 1000 then continues at 1035.

At 1035, if a first live bid is received, then at 1040 the display of the item is moved from the Showcase to elsewhere on the Live Auction display. The process continues at 1045 for a determination of whether the reserve value for the item was met by the live bid. If the reserve value was met, at 1050 “Reserve Met” or the like is optionally displayed within the Showcase for a short time as defined by online auction system 100, and then at 1055 “Reserve Met” or the like is added to the display. If the reserve value was not met at 1045, then at 1060 “Reserve Not Met” or the like is added to the display. In either case, process 1000 then ends and process 1100 begins at connector X.

Returning to the decision at 1035, if no live bid is received, process 1000 at 1065 determines whether a countdown threshold has been crossed. The countdown threshold is a predefined period measured from the beginning of the item auction. If the threshold has not been crossed, then process 1000 returns to 1035 to determine if a live bid has been received. If the threshold has been crossed, meaning that no live bids were received during the predefined threshold period, process 1000 continues at 1070, moving the display of the auction item from the Showcase to elsewhere on the Live Auction display. Then, at 1075, a blank avatar is displayed in the Showcase. A blank avatar may be, for example, an outline of a human head in profile. At 1080, if the auction for the item has ended, for example by the countdown completing or by auctioneer ending the item auction early, process 1000 ends and the Live Auction continues with the next item following an optional intermission. If the auction for the item has not ended, process 1000 continues at 1085 to determine if a live bid has been received. If a live bid has been received, the process continues at 1045. If a live bid has not been received, process 1000 continues at 1075, checking for live bids until the auction for the item ends.

In the exemplary implementation of FIG. 11, process 1100 begins, as mentioned above with respect to process 1000, at connector X after a first live bid has been received during an item auction. At 1105, a visual representation of the first bidder 120 is displayed in the Showcase in a first size, and may fill the entire the Showcase as was illustrated in FIG. 9. The first size is discussed herein as a large size; however, large is indicative of size only in relation to other visual representations in the display. Moreover, while size may be utilized in the exemplary approach, other approaches to differentiate between the most recent bidder and other bidders who had previously bid may be desirable (e.g., using color with the most recent high bidder highlighted in green, the previous high bidder in yellow and the third most recent high bidder in red). Icon differentiation such as through the use of different geometric shapes or the like may also be possible.

Process 1100 continues at 1110 when a bid is received at a higher value than the first live bid. It should be noted that if no higher bid is received before the countdown is finished (not shown) then process 1100 ends after 1105. At 1115 it is determined whether the higher bid was received from the first bidder 120 or a second bidder 120. If received from the first bidder 120, the process continues at 1105, such that the first bidder's 120 visual representation remains displayed in the Showcase. If, however the higher bid was received from a second bidder 120, process 1100 continues at 1120, wherein a large representation of the second bidder 120 is displayed in the Showcase. Continuing at 1125, a visual representation of the first bidder 120 is then displayed adjacent to the Showcase in the first position 970 in a second size smaller than the large size. The second size is referred to herein as a medium size. Thus, after 1125, the highest bidder 120 (now, the second bidder) is shown large-sized in the Showcase and the next highest bidder 120 (now, the first bidder) is shown medium-sized adjacent to the Showcase.

Continuing with the example of FIG. 11, at 1130 if the auction for the item ends, for example the countdown completes then process 1100 ends. Otherwise, the process continues at 1135 when a new bid is received. If it is determined at 1140 that the bid is from the first bidder 120, then at 1145 a large-sized representation of the first bidder 120 is displayed in the Showcase, and at 1150 a medium-sized representation of the second bidder 120 is displayed adjacent to the Showcase in the first position 970. Thus, after 1150, the highest bidder 120 (now, the first bidder) is shown large-sized in the Showcase and the next highest bidder 120 (now, the second bidder) is shown medium-sized adjacent to the Showcase. After 1150, process 1100 continues at 1130.

Returning to 1140, if the higher bid was not from the first bidder 120, it is determined at 1155 if the higher bid was from the second bidder 120. If yes, process 1100 continues at 1120 such that the display remains unchanged with the highest bidder 120 (the second bidder) shown large-sized in the Showcase and the next highest bidder 120 (the first bidder) shown medium-sized in the first position 970. If, however, at 1155 it is determined that the higher bid was also not from the second bidder 120, then the higher bid was from a third bidder 120 and the process continues at 1160. At 1160, a large-sized visual representation of the highest bidder 120 (now, the third bidder) is displayed in the Showcase. Then, at 1165, a medium-sized representation of the previous high bidder 120 is shown in the first position 970, and at 1170, a small-sized representation of the bidder 120 previously in the first position 970 is shown in the second position 975. Process 1100 continues at 1175. If at 1175 it is determined that the auction for the item has ended, process 1100 ends. If at 1175 the auction for the item has not ended, process 1100 continues when a higher bid is received, at 1180.

Upon receiving a higher bid, process 1100 continues at 1185 wherein the highest bidder 120 is shown in the Showcase. Next, at 1190, if the identity of the highest bidder 120 changed, meaning that the higher bid in 1180 was received from someone other than the current highest bidder 120, then the previous highest bidder 120 is displayed at the first position 970. The second position 975 is filled as appropriate at 1195, such that the first, second and third highest bidders 120 at any time are shown on the display. Note that each bidder 120 may sequentially bid multiple times even if the bidder 120 is the highest bidder 120 already, but each bidder 120 may only be displayed once on the Live Auction display. Thus, “first, second and third highest bidder” does not refer to the three highest bids, but rather refers to bidders 120 who have been shown on the display and not yet displaced by other bidders 120.

Following 1195, process 1100 continues at 1175, such that the three highest bidders 120 are always displayed and the hierarchy is updated at every higher bid until the auction for the item ends.

Not shown in FIGS. 10 and 11 is the effect of the placement of a Monster Bid. A Monster Bid may disrupt the item auction and reset the Showcase display to process 1100 at 1105. The Monster Bid and its effects are discussed in detail below.

### The Countdown and the Gauge

Included on the Live Auction display is a countdown Gauge. The Gauge 955 in FIG. 9 was shown as a ring around Showcase 960. The Gauge could alternatively be any other two- or three-dimensional object portrayed on the Live Auction display, for example, a bar, a box or concentric circles.

For the ring illustrated in the example of FIG. 9, at the beginning of an item auction in a Live Auction the ring is fully colored and as item auction progresses, the color in the ring begins to deplete to indicate the countdown to the end of the item auction.

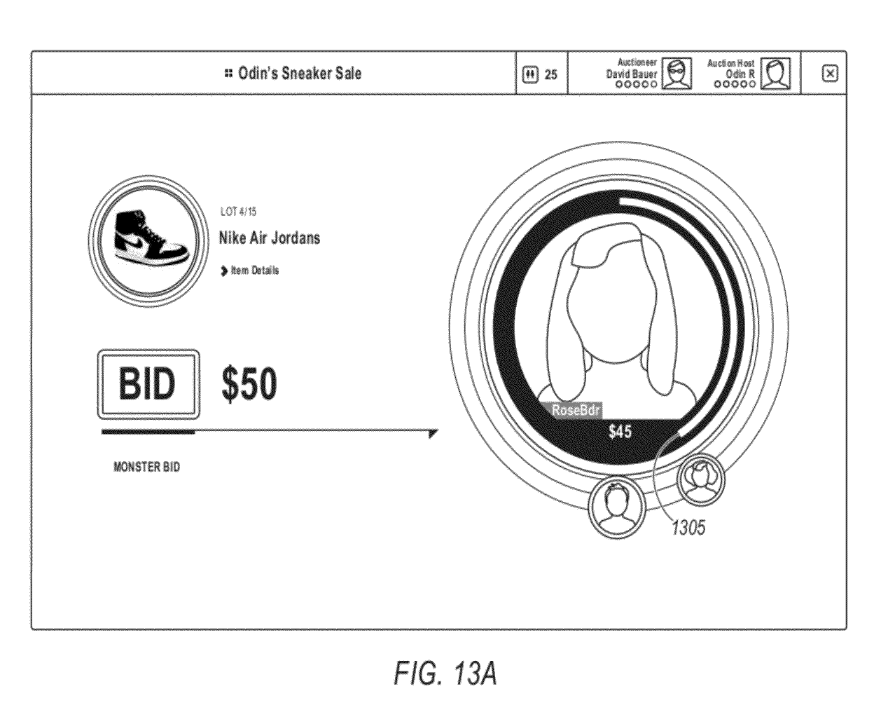

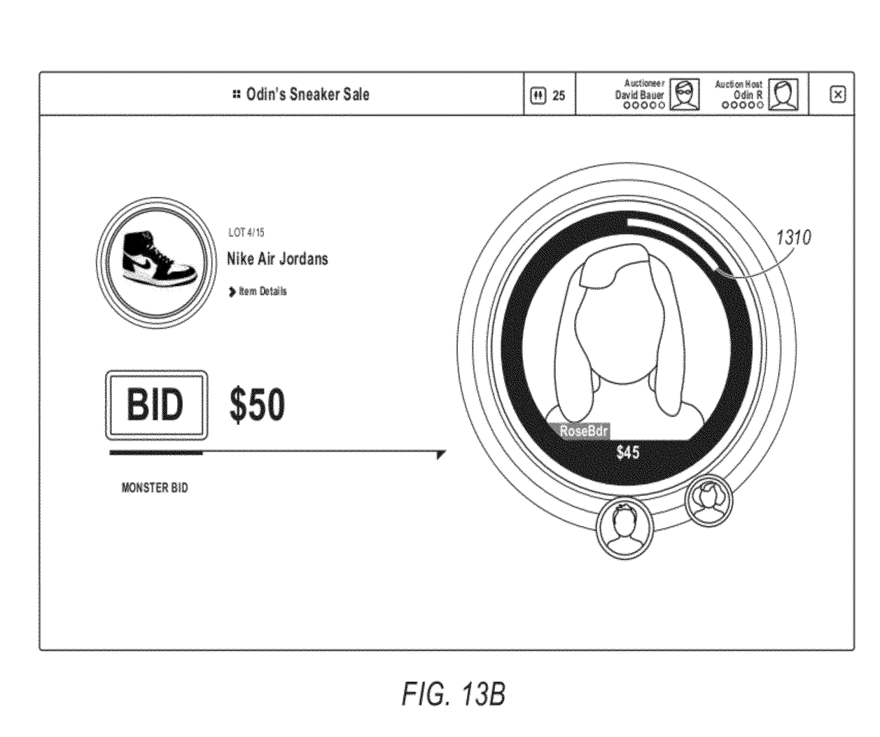

FIGS. 13A-B illustrate an exemplary implementation of a Gauge in which the color depletes from a ring by changing the color in sequential small segments starting from the top of Showcase 960 and proceeding counter-clockwise around to the top of Showcase 960 again. FIG. 13A shows color depletion to the “5 O'clock position” 1305, and FIG. 13B shows further color depletion to the “2 O'clock position” 1310. Clock position is mentioned for descriptive purposes only and is not intended to imply any particular relationship to time.

In one alternative implementation, the Gauge depletes color by gradually reducing the brightness or tone of the color or changing the color until it appears depleted. For example, the color may start as a vivid dark red and deplete by progressing through lighter and lighter shades of red until the Gauge appears white; or by progressing through orange, yellow, green, blue, indigo and violet; or by any other way to indicate a gradual depletion. No matter the method of showing color depletion, in a color-depletion implementation, the Gauge is completely depleted of its starting color at the end of the item auction countdown.

Instead of a color-depletion implementation, the Gauge may instead use a size-depletion visual indication for the countdown, or a movement-related indication for the countdown. Some representative examples of alternative Gauges include: a sphere that shrinks as the item auction progresses, a pair of curtains that close; a ball that drops; an auctioneer's hammer that approaches a table; and a vehicle progressing across the screen.

If no live bids are received during an item auction and the auction is not paused or stopped by auctioneer 118, the Gauge will progress to depletion or other indication of countdown completion without stopping. If auctioneer 118 chooses to pause the item auction, the Gauge halts its progression until the pause is finished, and then restarts its progression where it stopped. A pause may have a predefined duration, and the number of pauses available to auctioneer 118 in an auction event may be limited.

The Gauge indicates remaining duration value of an item auction. The remaining duration value at each instant is the calculated amount of time that the item auction will last if no bids are received and no auction parameters are changed going forward. The remaining duration value thus indicates an amount of time, but does not necessarily linearly relate to time, as will become clear from the discussion below. The initial remaining duration value may be a standard value in online auction system 100, or auction host 122 may have an option to define the value during auction creation. The initial value may alternatively be indirectly defined, for example by providing selectable options for a fast, medium, or slow auction, or by providing a sliding scale of auction paces. Online auction system 100 may translate the desired auction pace into an initial value for remaining duration. In the depletion ring example including the illustrations of FIGS. 13A-B, the Gauge indicates the initial remaining duration value with a fully-colored ring at the start of the item auction, and color depletion occurring as the remaining duration value decreases.

Auctioneer 118 may be provided with controls to modify the remaining duration value during a Live Auction, by speeding up or slowing down the Live Auction. For example, if there are few bidders 120 and a lot of time between bids in an item auction, auctioneer 118 may speed up the auction to get to the next item more quickly, or to add excitement into the auction. Conversely, in a very active item auction, auctioneer 118 may want to slow down the auction to encourage the highest bid possible by providing more time for the competition to continue. When the Live Auction is sped up, the Gauge appears to speed up. For example, in a color-depletion implementation, if the remaining duration was indicated as 75% of the initial duration value before a speed-up, it will still be 75% immediately after the speed-up. However, going forward the color is depleted more rapidly. Conversely, color is depleted more slowly after an auction slow-down.

The pace of a Live Auction or a constituent item auction may, instead of being constant, vary according to formula. For example, a Live Auction may speed up or slow down; may be fast at the beginning and end and slow in the middle; or may speed up and slow down in some other fashion. Online auction system 100 may provide an option for auction host 122 to configure an auction pace profile during auction creation. For example, auction host 122 may be provided controls to adjust the coefficients in a mathematical equation, or may be provided a visual method for modification such as the ability to change the slope or curve of a line on a graph. Alternatively or additionally, auctioneer 118 may be provided with controls to dynamically set or change the profile during the Live Auction.

In one exemplary implementation, the progression of an item auction is defined with a quadratic equation, shown in Equation 1, wherein “x” represents elapsed time since the start of the item auction and “f(x)” represents the remaining duration value. Equation 2 shows the first derivative of Equation 1, representing the velocity of the countdown at any point in the countdown. Equation 3 shows the second derivative of Equation 1, representing the acceleration of the countdown, wherein acceleration indicates change of pace either in a positive or negative direction. Thus, by changing the equation coefficients a, b, and c, the character of the item auction may be changed.

f(x)=mx²+nx+p (1)

v(x)=2mx+n (2)

a(x)=2m (3)

Solving Equation 1 for initial conditions (i.e., at x=0, the start of the item auction) results in an initial value for “f(x)” of “p” as shown in Equation 4.

f(x=0)=p (4)

Coefficient “p” may be positive, negative, or zero. Generally, coefficient “p” would be zero so that the expected duration of an item auction as represented by the initial remaining duration value would be equal to the countdown. However, other coefficient values are also possible. For example, a negative coefficient “p” would cause the remaining duration value to reach zero prior to the end of the full countdown. The Gauge in this case would indicate that the auction for the current item had ended even though the countdown was not actually complete, and the extra time in the countdown could be used to include a post-auction period. A post-auction period, for example, could provide time for negotiation between the auctioneer 118 and the highest bidder 120 when the reserve is not met on an item.

Solving Equation 2 for initial conditions (i.e., at x=0) results in the initial velocity “n” as shown in Equation 5.

v(x=0)=n (5)

Coefficient “n” may be positive, negative, or zero, to set the initial velocity of the countdown. Generally, coefficient “n” would be a positive value so that initial velocity of the countdown is positive, meaning that the countdown is progressing toward the end of the item auction at a velocity “n”. Note that the term “countdown” itself represents progression toward the end of the Live Auction, but does not necessarily involve the concept of mathematically counting down. Thus, if coefficient “n” was set to a negative number, conceptually the countdown would progress away from the end of the item auction such that the duration of the item auction would be increased.

Considering acceleration as in Equation 3, it is seen that the coefficient “m” may be positive, negative, or zero, making the countdown accelerate, decelerate, or remain constant, respectively.

As mentioned, online auction system 100 may provide configuration options to auction host 122 during auction creation to create a profile for the auction progression. Configuration options may include selection of fast, medium, or slow pace and/or selection of fast, medium, or slow acceleration, where selection may be made through radio buttons or the like or through a sliding scale selection. Other configuration options may include options to directly modify the coefficients of Equation 1. Note that profiles may be defined for individual item auctions or over the whole of the Live Auction. Auctioneer 118 may also be provided with selectable pace and/or acceleration options for modifying the progression profile before or during the Live Auction.

If no live bids are received during an item auction, the countdown progresses according to the pace and acceleration profile of the item auction or Live Auction. If a valid live bid is received during the item auction, meaning that the live bid is higher than the current bid of record by at least a predefined amount, then the higher bid is considered to be a trigger bid that triggers modification of the remaining duration value. If multiple bids are received at a same valid bid value, the first bid received at that bid value is the trigger bid. When a trigger bid is received, the variable “x” of Equation 1 is decreased, effectively taking a step backward in time. Correspondingly, the value of the function “f(x)” will change to reflect the change in “x” according to Equation 1. Conceptually, the countdown is set back. The Gauge is updated to indicate that more of the countdown now remains. If the Gauge is, for example, a ring around Showcase 960 as illustrated in FIG. 9, some of the color that was previously depleted is returned to the Gauge, making it appear as though the Gauge was recoiled. For ease of use, the decrease of the variable “x” in Equation 1 and the corresponding effects of the decrease are referred to as Recoil from this point forward.

The amount of Recoil to use depends on the desired style of the Live Auction. A one hundred percent 100% Recoil would restart the countdown each time a higher live bid was received, whereas a zero percent 0% recoil would not modify the countdown when a higher live bid was received. Some percentage Recoil could introduce an excitement factor into the Live Auction, but a 100% Recoil could cause a Live Auction to extend too long.

Online auction system 100 may include a standard Recoil feature with a set Recoil value, or may provide auction host 122 a configuration option during auction creation to include the Recoil feature and set the Recoil value. Additionally or alternatively, auctioneer 118 may be provided options during the Live Auction to turn the Recoil feature on and off and to set the Recoil value. Setting the Recoil value could include selecting between predefined percentages, such as 30%, 50%, or 70%, and/or selecting a percentage on a sliding scale from, for example, 0% to 100%.

Recoil may be implemented according to a formula or a look-up table in a memory. In one exemplary implementation, Recoil is defined using a linear relationship, shown in Equation 6, wherein “x” represents the elapsed time since the start of the item auction and “x=0” represents the start of the item auction, as was the case for Equation 1 above. In Equation 6, the value of the function “g(x)” represents the amount of Recoil as a function of how far the item auction has already progressed.

g(x)=rx+s (6)

Coefficients “r” and “s” may be any value, but generally will be positive values between zero 0 and one 1 to extend the duration of the item auction without increasing beyond the initial duration value. For example, if “s” is equal to zero and “r” is equal to one, then the value of the function “g(x)” will be equal to the value of the elapsed time in the item auction, or 100% Recoil, for every trigger bid received. If, however, “s” is equal to zero and “r” is equal to “1.1”, then the value of the function “g(x)” will be greater than the elapsed time in the item auction, and the Recoil will extend the duration beyond the initial duration value, and as such, the Live Auction could continue for a very long time. Negative values for “r” or “s” could shorten the duration. For example, if “s” is equal to zero and “r” is equal to “−0.5”, then every trigger bid would shorten the duration of the Live Auction by one half of the elapsed time in the item auction, or 50% Recoil. Although in these examples, coefficient “s” has been zero, “s” may be used to further shape the Recoil.

Visually, the exemplary Gauge 955 illustrated in FIG. 9 would appear to “recoil” a percentage of the way back to a full color ring on each trigger bid. If the Recoil was 50% and the color were depleted in the exemplary ring counterclockwise from a starting point at the “12 O'clock position” to the “6 O'clock position”, then the Recoil would cause the color to fill back in halfway to the “9 O'clock position”, or 90 degrees clockwise. Continuing with this example, Recoil from the “2 O'clock position” would be back to the “7 O'clock position”, or 150 degrees clockwise. In this example Recoil is larger the longer it has been since the last trigger bid.

In one implementation, the amount of Recoil may also be affected by the current bid amount. More expensive items represented by a current bid amount may be given more time in an auction in terms of Recoil as compared to inexpensive items. Merely by way of example, the Recoil amount may be calculated according to Equation 6 and then multiplied by a value of 1.1 for items where the current bid is over $100 and by a value of 1.2 for items where the current bid is over $1000, with the total adjusted Recoil value not exceeding the difference of the initial remaining duration value minus the current remaining duration value. Thus, bid amount or other variables may also affect the Recoil function.

Note that references to elapsed time do not refer to actual time elapsed in the item auction because each trigger bid may cause the elapsed time to be modified. Thus, elapsed time actually refers only to the current value of “x” in Equations 1-6.

The Recoil function may change throughout the Live Auction. As noted above, the coefficients of a formula may be modified during a Live Auction. Alternatively or additionally, a new formula may be used for stages within an item auction. For example, for a time equal to 25% of the initial duration value no Recoil is used, then 30% recoil is initiated for the remaining duration of the item auction.

As can be seen from the above discussion, the Gauge is updated as an item auction progresses. For example, in the implementation of FIG. 9, the color in the ring is depleted related to the value of the function “f(x)” in Equation 1, and replenished related to the value of the function “g(x)” in Equation 6. Therefore, Participants in the Live Auction may see the color in the ring and instinctively understand how close the item auction is to the end. As mentioned, the Gauge may be presented in many other forms, and in each form the Gauge is designed to heighten the awareness of the progression of the item auction to increase competitive bidding.

### Bidding

The Live Auction display includes a bid entry area. In the example described with respect to FIG. 9, the bid entry area includes a bid button 940 and an indication 945 of a value that would be submitted if the bid button 940 were selected. The value is the current high bid value plus a predefined increment. The increment may be predefined as a standard in online auction system 100 or may be set by auction host 122 during auction creation. For non-monetary auctions, the increment is generally set to one (1). In one implementation, the increment may be modified by auctioneer 118 during the Live Auction. For example, if bidding activity in an item auction is heavy, the increment may be increased to slow the bidding and regain control of the item auction. If bidding activity is light, the increment may be decreased to encourage more Participants to bid.

When a Participant selects to submit a bid, for example by pressing the bid button 940 in the example of FIG. 9, the value indicated is submitted into online auction system 100 and is binding on the Participant as an offer to buy the item at auction at that price. If the bid is the highest bid for the item at the end of the auction on the item and the bid exceeds the reserve price, then the bid becomes the sale price and the Participant must submit that sale price into online auction system 100 following the Live Auction.

When a bid is submitted on an auction item that is higher than the current bid, the bid value, as shown adjacent to the bid button in FIG. 9, is automatically increased by the predefined increment.

In the Live Auction bid entry area, there is an area that may be occasionally offered to the Participant to place a user-defined bid. The user-defined bid includes a significantly larger increase over the current high bid than the predefined increment would be, and so is referred to herein as a Monster Bid. The Monster Bid may be limited as to its upper and lower values. For example, the Monster Bid may be limited to a minimum of 10% and a maximum of 200% over the current high bid.

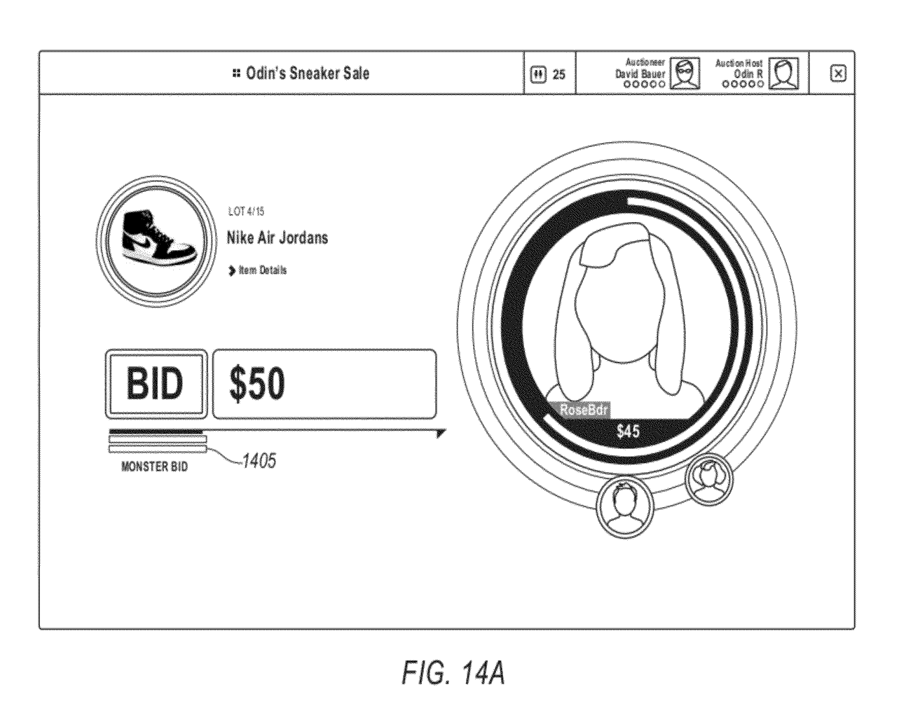

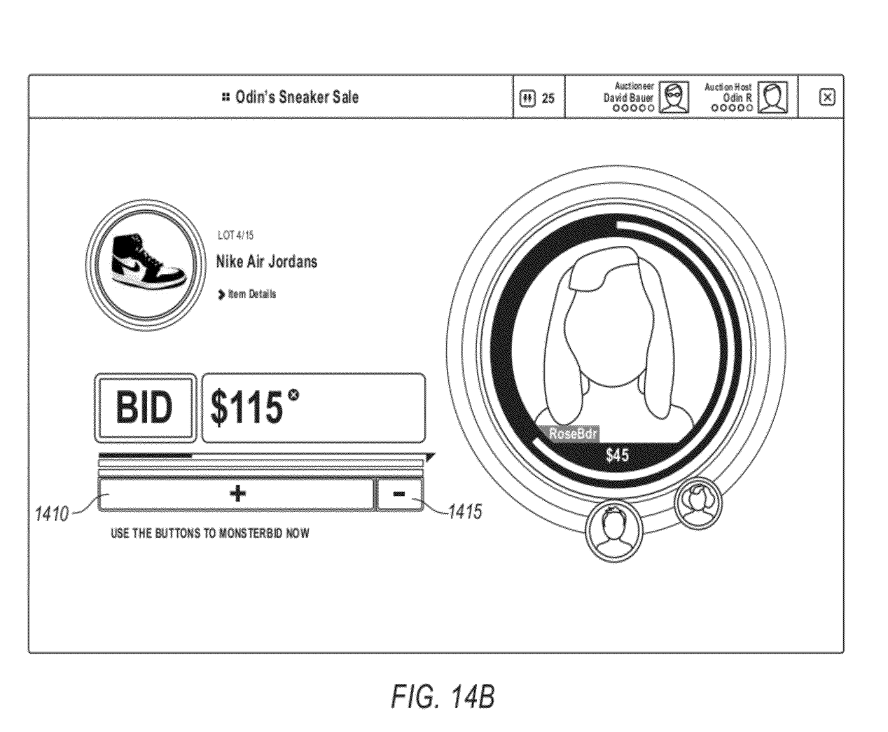

A Participant may earn the opportunity to place a Monster Bid. After a bidder 120 has submitted a predefined number of bids in an item auction, the Monster Bid option is presented to the bidder 120. While earning the Monster Bid option, the bidder 120 may see a progress indicator. In FIG. 14A, the progress indicator is shown as a green bar 1405, and for each bid submitted, the green bar grows until Monster Bid status is earned, as shown in FIG. 14B. In the example of FIGS. 14A and 14B, the number of bids required to be submitted is three, and so the green bar grows one-third its maximum length for each submitted bid. When a Monster Bid has been earned, up and down selection options are added to the bid entry area on the display. In the example of FIG. 14B, the up and down options are illustrated as plus “+” and minus “−” buttons 1410 and 1415, respectively. Continuing with the example of FIG. 14B, the bidder 120 may choose to enter a Monster Bid value by pressing the plus button to increase the bid value over the default incremented value, refine the bid value using the up and down options until the bid value is as desired, and then press the bid button to submit the selected Monster Bid value. Not shown in FIG. 14B is the option for a bidder 120 to alternatively submit a bid with a standard increment, and save the Monster Bid option for a later point in the item auction.

A Monster Bid temporarily disrupts the item auction by halting all action to let other Participants see the new bid and adjust their bidding strategies accordingly. The disruption feature may encourage higher bidding activity as bidders 120 attempt to earn the power to disrupt the auction.

Disruption may include visual and audio bomb-like effects, for example, explosion sounds, circles shown emanating out from the Showcase, color bursts, pulsations, and fireworks, and may cause tactile effects such as vibration in a smart phone or hand-held input device. Disruption may further include graphics such as showing the visual representations of the three high bidders 120 flying off the display, followed by displaying in The Showcase the visual indication of the bidder 120 who submitted the Monster Bid. The Monster Bid may cause changes to the item auction progression. For example, following a Monster Bid, the countdown may restart from the beginning and the Gauge may correspondingly indicate the initial remaining duration value.

A Monster Bid may override bids received from other bidders 120. For example, as discussed above a bid may cause a Recoil according to Equation 6, whereas a Monster Bid will interrupt the calculation of Equation 6 and the display of the updated Gauge, and set the remaining duration value to a new value and update the Gauge accordingly.

Following a Monster Bid, the item auction progresses as per the flow diagram of FIG. 11 to fill out the display of the three highest bidders 120. In one implementation, the bidder 120 that placed the Monster Bid must bid an additional predefined number of times to earn the option to place another Monster Bid. In another implementation, once a bidder 120 earns the option to place a Monster Bid the bidder 120 retains the option throughout the item auction or auction event.

In some implementations, the Live Auction display may provide a warning that a bidder 120 is contemplating placing a Monster Bid. For example, when a bidder 120 begins pressing the plus and minus buttons to select a Monster Bid value, the other Participants may see a visual representation or the name of the bidder 120. The warning may function to heighten the competition between the bidders 120.

### Auctioneer Controls

During the Live Auction, the current auctioneer 118 has the option to control various aspects of the auction through the use of selection options on a control panel. Auction host 122 may also have a control panel including some or all of the control options that auctioneer 118 has. Auction host 122 may have additional controls. Thus, although the controls are discussed in some cases below in terms of availability to auctioneer 118, the descriptions may apply equally to controls available to auction host 122.

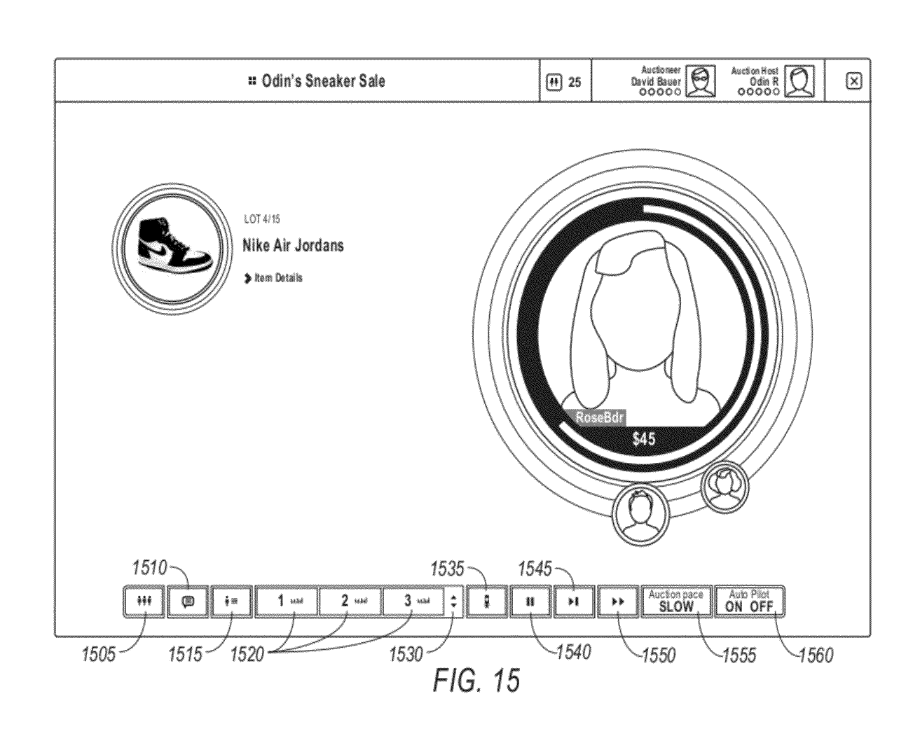

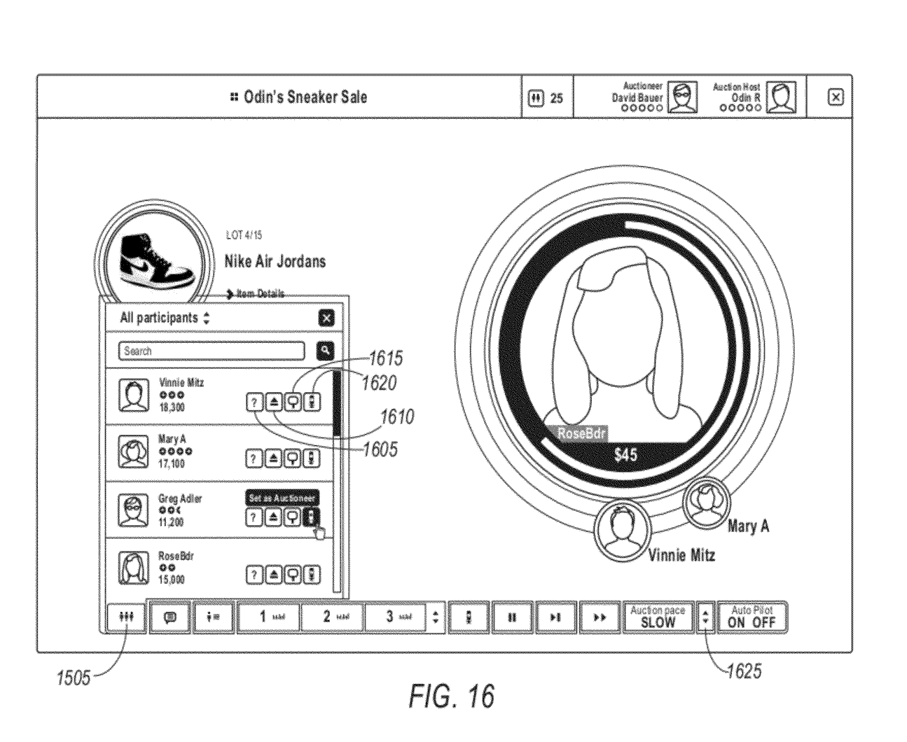

FIG. 15 illustrates an exemplary control panel as a row of selectable control buttons, including a Participant list selection option 1505 (described below with respect to FIG. 16), an auctioneer “message” option 1510, a “note” option 1515, “sounds” option 1520 scrollable through multiple sounds with scroll bar 1530, a microphone option 1535, a “pause” option 1540, a “resume” option 1545, a “skip” option 1550, change auction pace option 1555, and autopilot option 1560. Additionally, the control panel may include options for changing the acceleration of the Live Auction, for changing the appearance of the display, and other useful controls.

The control option “message” 1510 in the example of FIG. 15 allows an auctioneer 118 to create a message and then post it for the Participants to view. For example, if the “pass the microphone” option 1620 is exercised and auctioneer 118 is about to pass control to another Participant, auctioneer 118 may elect to post a message to the Participants that an auctioneer 118 handoff is imminent.

The control option “notes” 1515 in the example of FIG. 15 allows an auctioneer 118 to open a note page and view notes already written. The note page may be used, for example, as a reminder page of notes made by auctioneer 118 before the auction event or instructions from auction host 122 made prior to the auction event. In one implementation, the note page may be used as a scratch pad for auctioneer 118 to make notes during the Live Auction.

The control option 1520 in the example of FIG. 15 for “sounds” allows auctioneer 118 to generate entertaining noises, such as horns or sirens. If there are too many sound options available to show on the control panel, a scroll option such as scroll arrows 1530 may be included for scrolling through the sound options.

The microphone control option 1535 in the example of FIG. 15 may be used to send a verbal message to one or more Participants. Auctioneer 118 may select microphone option 1535, select one or more Participants to hear the message, and then begin speaking. In one implementation, microphone option 1535 is a mute option for muting all sounds in the auction event. In one implementation, microphone 1535 is used to select sending verbal messages to Participants as described or to select to mute all sounds.

The control options “pause” 1540 and “resume” 1545 in the example of FIG. 15 allow an auctioneer 118 to stop the Live Auction for a predefined amount of time, as discussed above, and then to resume the Live Auction when ready. If auctioneer 118 does not select the resume option 1545 before the end of the predefined time, the Live Auction may resume automatically. The number of pauses allowed an auctioneer 118 in one Live Auction may be limited, and once the allowed number of pauses has been used, the pause 1540 and resume 1545 options may either be removed from the control panel or be disabled. During a pause, a notice is displayed indicating that the Live Auction is paused, and a timer displays the amount of time remaining in the pause before the Live Auction will resume automatically. Other indications of time remaining in the pause may also be displayed; for example, the exemplary ring around Showcase 960 of FIG. 9 may pulsate during a pause. If no bids are received during a pause, the remaining duration value is unchanged. If bids are received during a pause, the highest bid is accepted and there may be Recoil if applicable.

The control option “skip” 1550 in the example of FIG. 15 allows an auctioneer 118 to move to the next item in the auction without completing the auction for the current item. Auctioneer 118 may select the skip option, for example, if there is low or no bid activity or the bid values are far below the reserve price with no expectation of reaching the reserve price. A reserve price is the minimum price at which the seller of the item is willing to sell. If the reserve price is not met at the end of the auction, then the item is not sold. An auctioneer 118 may choose to skip an item for other reasons, for example, if a seller decides in the middle of the auction to not sell the item. In an alternative implementation, the online auction system 100 may only allow a skip if there are no early bids, or before a bid is received in the item auction. In some implementations, an auctioneer 118 may further have the capability to bring a skipped item back into the auction by, for example, pausing the auction and adding the item into the queue of items to be auctioned.

The control options “speed up” and “slow down” in the example of FIG. 15 allow an auctioneer 118 to control the pace of the Live Auction, as described above with respect to the countdown Gauge. As illustrated in the example of FIG. 15, auctioneer 118 may select the option to speed up or slow down by pressing the up and down arrows 1625 next to the “Auction Pace” button 1555. In this example, auctioneer 118 may select slow, medium, and fast; however, as discussed above with respect to the countdown Gauge, a control panel may include instead or additionally a sliding scale option for selecting from any pace between a predefined minimum and maximum pace. The control panel may also include options for changing the acceleration of the Live Auction, as discussed above with respect to the countdown Gauge.

The control option “autopilot” 1560 in the example of FIG. 15 allows an auctioneer 118 to stop controlling the Live Auction and let the auction progress in a predefined manner, such as with a set pace and acceleration and in the order specified by auction host 122 during auction creation. Auctioneer 118 may regain control of the Live Auction by turning off the autopilot. In the example of FIG. 15, auctioneer 118 may select the “Auto Pilot” button 1560 to toggle autopilot mode between “ON” and “OFF”.

FIG. 16 illustrates options included in the Participant list selection option 1505 of FIG. 15 related to individual Participants, such as “chat” 1605, “eject” 1610, “flag” 1615, and “pass the microphone” 1620.

The control option “chat” 1605 in the example of FIG. 16 allows an auctioneer 118 to communicate with one or more Participant via a text message or voice message. As illustrated in the example of FIG. 16, the option to send a message to a Participant may be selected by opening the list of Participants 1505 and selecting the chat icon 1605 next to a Participant's name Alternatively, a messaging option on the control panel may allow auctioneer 118 to prepare a message and select one or more Participants to receive the message. In one alternative implementation, the Participants who receive communications from auctioneer 118 may reply by selecting a reply option that is displayed for a predefined time after a message is received.

The control option “eject” 1610 in the example of FIG. 16 allows an auctioneer 118 to remove a Participant from the Live Auction. For example, an auctioneer 118 may wish to eject a Participant if the Participant is attempting to inflate a sale price by speed-bidding, meaning submitting multiple bids in a fast sequence to give the appearance of a competition to acquire the item. Speed-bidding may be allowed in some implementations although if it is it may be limited to a number of sequential bids. However, even if permitted, if it becomes clear that speed-bidding is being used for improper purposes, auctioneer 118 may choose to eject the Participant. As illustrated in the example of FIG. 16, the option to eject a Participant may be selected by opening the list of Participants 1505, and selecting the eject icon 1610 next to a Participant's name. The ejected Participant may then receive a message indicating the ejection and the reason for the ejection. The ejected Participant may be prevented from returning to the auction event. Note that an ejected Participant may lose any points earned during the Live Auction. Points are discussed in detail below.

The control option “flag” 1615 in the example of FIG. 16 allows an auctioneer 118 to push a bidder 120 into the Showcase to push the bidder 120 to bid. As illustrated in the example of FIG. 16, the option to flag a Participant may be selected by opening the list of Participants 1505, and selecting the flag icon 1615 next to a Participant's name.

The control option “pass the microphone” 1620 in the example of FIG. 16 allows an auctioneer 118 to pass control to another Participant in the Live Auction. As illustrated in the example of FIG. 16, the option to pass the microphone may be selected by opening the list of Participants 1505, and selecting the microphone icon 1620 next to a Participant's name. After selecting the microphone icon 1620, auctioneer 118 is shown a message that the system is waiting for a response from the Participant invited to take control. If the other Participant declines to assume control, auctioneer 118 is shown a message that the other Participant has declined. However, if the other Participant accepts, the current auctioneer 118 may then relinquish control by selecting a control release option. Only one Participant may have auctioneer 118 control at a time, and therefore an auctioneer 118 retains control until selecting the control release option even if another Participant has accepted control. In one implementation, the auctioneer 118 does not have the option to pass control. In this case, only the auction host 122 is provided the option 1620 to request for a Participant to take control. The Participant may accept or reject the request.

A control panel may provide options, not shown in the examples of FIGS. 15 and 16, for changing the appearance of the Live Auction display during the Live Auction, for example to change background colors, the shape of the Showcase, or the form and location of the Gauge.

A control panel may provide more options or fewer options than those described above. Online auction system 100 may provide a standard control panel for display. Alternatively, an auction host 122 may be provided the option during auction creation to configure the control panel by, for example, adding selection options, changing the layout, and changing text formatting.

The control panel remains visible to the current auctioneer 118 as long as the Participant retains the role of auctioneer 118, including during the transition between items for sale.

### Intermission

The transition between items in the Live Auction is the intermission. At the end of an item auction, a winning screen displays the winner's visual representation and/or name and winning bid in or near the Showcase for a predefined amount of time, generally a few seconds. During this time, the winning bidder 120 may see a different winning screen than do the other Participants in the Live Auction. For example, the winning bidder 120 may see a message “You Won!” or the like and picture of the item won, whereas the other Participants may see only the name of the winner and the winning bid. Intermission begins following the winning screen.

During intermission, a scoreboard is displayed to all Participants. Scoring is discussed in detail below. The scoreboard identifies some number of the Participants. For example, the scoreboard may display the ten bidders 120 with the highest number of points in the last item auction or in the Live Auction, or any bidders 120 with more than a certain number of points. Alternatively, all Participants may be displayed on the scoreboard, and there may be scroll options to allow for viewing the entire list of Participants. The scoreboard may include the name of the Participant, the Participant's score and rating, a category identifier for the auction, such as “winner” or “pusher”, and a category identifier for the user across all auctions, such as “master” or “apprentice”. The scoreboard may include other information regarding the Participants such as familial, business, or collegiate relationship.

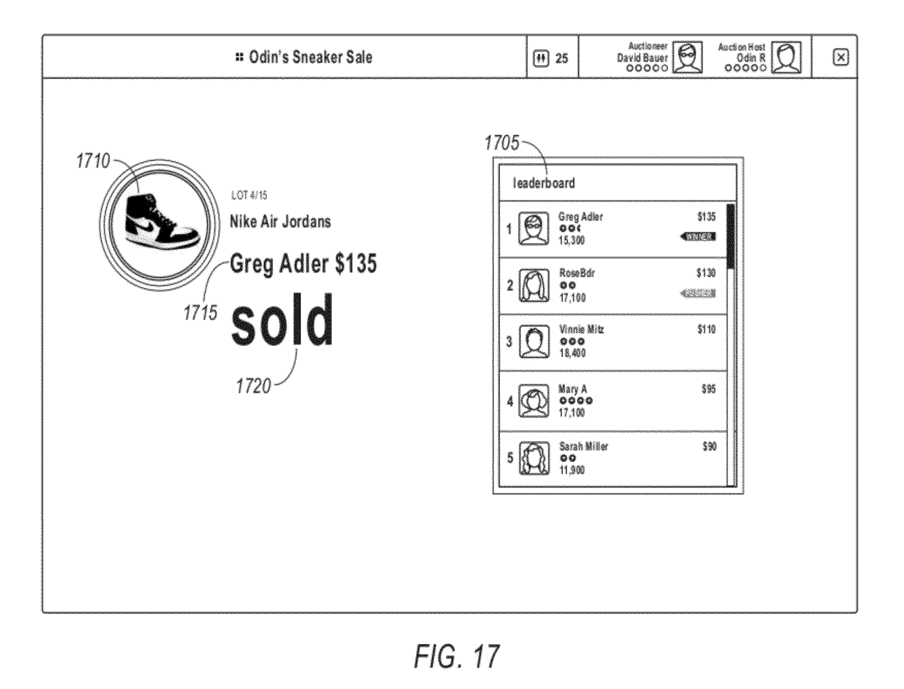

FIG. 17 illustrates one exemplary implementation of a Live Auction display during intermission, where an exemplary scoreboard 1705 is displayed (entitled “leaderboard”) along with a picture 1710 of the item just sold, an indication 1715 of the winner and selling price, and an indication 1720 that the item was sold in the auction.

In another exemplary implementation of a Live Auction display during intermission, the item to be auctioned next may be displayed in or near a Showcase. Also displayed in or near the Showcase may be the starting bid value for the item, either as set by auction host 122 during auction creation or as set by pre-bids. If there is no starting bid value, meaning that no starting bid was set by auction host 122 and no pre-bids were received, then no bid value is displayed.

During intermission, Participants may browse the Gallery. During intermission, auctioneer 118 or auction host 122 may exercise any available controls, for example may modify the pace or profile of the Live Auction, may send voice or text messages to Participants, switch the order of the items to be auctioned, eject Participants, pass control to another Participant, pause the auction event, make notes, or select any other options available on the control panel. At the end of intermission the auction of the next item automatically begins by providing a bid entry area to the Participants.

In an alternative exemplary implementation for transitioning between items, after the winning screen of an item auction, a scoreboard may be displayed for a predefined time, followed by a display of the next item to be auctioned and a bid entry area. In this implementation, as soon as the next item is displayed, bidding may begin on the item.

The progression of the intermission and the format of the intermission display may be a standard set by online auction system 100. Alternatively, auction host 122 may have options for configuring the intermission during auction creation. For example, auction host 122 may have an option to set the duration, to determine the contents of the displays, and to determine what auctioneer 118 controls will be allowed for the intermission.

### Points and Scoring

Participants in a Live Auction may earn points during the Live Auction. In some implementations, points may be earned only by bidders 120 in the Live Auction. Points are accumulated during each item auction in a Live Auction, and updated point totals may be displayed on the scoreboard during intermissions and at the end of the Live Auction. The total points earned in a Live Auction are added to a cumulative score (Score) of the user. The Score accumulates in one implementation across all auctions in which the user is a Participant although they may expire such as if unclaimed after a period of time. A user may have separate Scores for each of the roles Participant, host 122, and auctioneer 118.

Points and Score serve multiple functions in online auction system 100. Awarding points induces competitiveness during a Live Auction and encourages users to participate in multiple auctions. A user may “play” an auction like playing a game, learning to maximize points, and thus there is entertainment value for the user. The user also earns social status through high points earned in a Live Auction and through a high Score. Further, the user may build credibility as an auction Participant, bidder 120, host 122, or auctioneer 118, as applicable.

An auction host 122 may use the point totals in a Live Auction to determine the Participant with the highest point count, and reward that person with a host gift. Online auction system 100 may provide incentive to increase Scores, by providing for an exchange of points. For example, a user may cash in one thousand points for one free entry into an auction event, or system 100 may allow only those users with at least 100,000 points to join special “preferred participation” auction events. As another example, system 100 may provide for a user to donate points to charity, such that system 100 would donate some amount of currency to charity proportional to the amount of donated points. Points and Scores may provide many other benefits and uses in addition to those described.

In addition to Participant points, an auction point bucket (Bucket) for the Live Auction is increased proportionally each time a Participant in that Live Auction earns points. For example, if the proportion is one-to-two (1:2), then for every two points earned by a Participant, the Bucket is increased by one point. Thus, at the end of the Live Auction, the sum of all of the Participants' points is proportional to the total of the points in the Bucket. There may additionally be a Bucket for each item auction. In an implementation in which there are item auction Buckets, the winner of the item may be awarded a number of winner points equal to the points in the Bucket and a pusher in the item auction may be awarded a number of points equal to a portion, for example half, of the points in the Bucket. A pusher may be, for example, a bidder that pushes the selling price by submitting multiple bids in a bidding war against the winner. A pusher may simply be the second highest bidder or may be defined in a more complex way according to the timing and/or frequency of bids.

A Live Auction with a large number of bidders 120 may tend to have more bidding activity than a Live Auction with a small number of bidders 120 and thus the points earned may be vastly different. To account for this, the points for a Live Auction are normalized using a factor (Bidder Factor) related to the number of Participants in the auction, or the number of bidders 120 in the auction. The Bidder Factor may be determined formulaically, for example by multiplying a fractional number by the number of bidders 120. In this example, if the fractional number was 0.1 and the number of bidders 120 was 20, then the Bidder Factor would be 2.0 and a Participant's point total in the Live Auction would be multiplied by 2.0 before being added to the Participant's user Score. Normalization using a Bidder Factor also reduces the scoundrel influence on the scoring system, meaning that users conducting many small mock auctions to drive up Scores will be discouraged by the Score reduction from the Bidder Factor.

In one illustrative implementation, the Bidder Factor is set by category instead of being set formulaically. For example, there may be only three Bidder Factor categories: a category for one to three bidders 120 with a Bidder Factor of 0.5; a category for four to eight bidders 120 with a Bidder Factor of 0.75; and a category for nine or more bidders 120 with a Bidder Factor of 1.0. In this implementation, the scoundrel auction effect is minimized, while at the same time recognizing that beyond a certain number of bidders 120, additional bidders 120 may not make the auction more competitive.

Having described points, Scores, the Bucket, and the Bidder Factor, an exemplary award plan is now discussed. Table 1 includes a list of exemplary actions that may result in points being awarded to a Participant in a Live Auction. Tables 2 and 3 include exemplary points awarded for being an auction host 122 or auctioneer 118, respectively. Note that each table is in terms of points that will be added to the Score, meaning that the raw auction points are adjusted by the Bidder Factor (shown as BF) where applicable.

TABLE 1
Exemplary award system - Participant Score

| ACTIVITY | AWARD |
|---|---|
| Join the Live Auction | Points = 1,000 each for the first five |
| no points for rejoining | users to join; |
| | Points = 200 each for the next ninety- |
| | five users that join |
| Join the Live Auction from | Points = 100 * (number of Participants) |
| the Lobby | |
| Place the first bid | Points = 10 |
| Place a live bid | Points = BF * (number of Participants) * |
| | (bid number) |
| Place a Monster Bid | Points = BF * (number of Participants) * |
| | (bid number) * 2 |
| Be the winner of an item | Points = BF * (value of item Bucket) |
| Be the winner of multiple | Points = BF * (200), for second item; |
| items | Points = BF * (300), for third item |
| Place bids on multiple items | Points = BF * (400), for second item; |
| | Points = BF * (600), for third item |
| Be second highest bidder on | Points = BF * (value of item Bucket)/2 |
| an item | |
| Earn more points in an item | Points = BF * (value of item Bucket) * 2 |
| auction than the winner of | |
| the item | |
| Join at the beginning and stay | Points = 100 * (number of items in |
| for the entire Live Auction | Live Auction) |
| Make a counterbid for an item | Points = (value of item Bucket)/2 |
| when reserve not met | |
| Earn most points in the Live | Multiply Participant's total points by 1.5 |
| Auction | |

TABLE 2
Exemplary award system - auction host Score

| ACTIVITY | AWARD |
|---|---|
| Host the auction | Points = BF * (value of Live Auction Bucket) |

TABLE 3
Exemplary award system - auctioneer Score

| ACTIVITY | AWARD |
|---|---|
| Auctioneer for one or more | Points = BF * (sum of the values of |
| items in one Live Auction | the item Buckets for items auctioned |
| | by auctioneer) |
| Auctioneer for entire Live Auction | Points = BF * (value of Live Auction |
| if more than two items auctioned | Bucket)/(number of items auctioned) |

In some implementations, to encourage live bidding, a user does not earn points by submitting pre-bids.

Because points are awarded according to type of Participant activity and the timing of the activity, the Participant with the highest point count may be any bidder 120 in the Live Auction, including a bidder 120 who did not win any item. In the example of Table 1, this is illustrated by awards for the activities “Earn more points in an item auction than the winner of the item” and “Earn the most points in the Live Auction.”

An adjustment factor may account for differences in item value between auctions. For example, there may be a multiplying factor of two 2 for auctions with items valued over one thousand dollars $1,000, such that auction points are multiplied by two before being added to the user's Score.

Points and Scoring allow online auction system 100 to provide objective feedback to Participants based on activity within Live Auctions. Additionally, Participants may provide subjective feedback to auctioneer 118, auction host 122, and other Participants.

### Participant Feedback

One example of Participant feedback is applause. During a Live Auction, a Participant may want to let auctioneer 118 know that the Participant is enjoying the auction, or that the Participant approves of the way auctioneer 118 is conducting the auction. The Participant may therefore select to applaud auctioneer 118. Applause is generated by selecting an applause button on the Live Auction display.

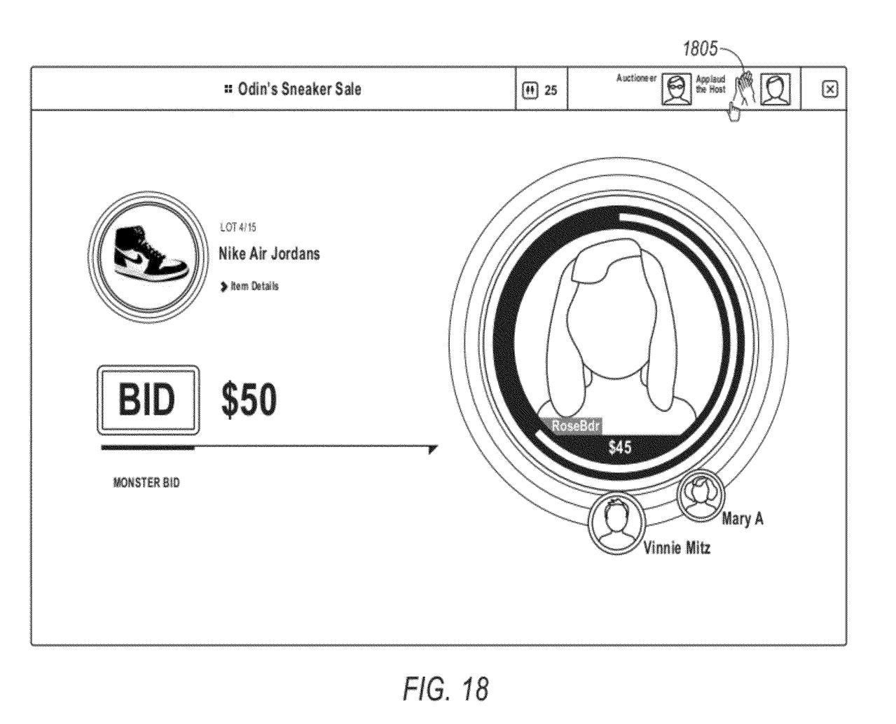

FIG. 18 illustrates an exemplary implementation of an applause option, where an applause button is identified by an icon 1805 with hands clapping together. When a Participant selects to applaud, auctioneer 118 and the other Participants may hear an applause sound for a predefined amount of time. If the Participant selects and holds the applause option, the applause sound volume gradually increases to a limit. If multiple Participants select to applaud at once, the applause sound volume is increased accordingly. For example, if a first Participant selects and holds an applause button, the applause sound begins at a first level and then gradually increases to a first limit. Then, if a second participant selects and holds an applause button, the applause sound volume first increases to a second level and then gradually increases to a second limit. Levels and limits are predefined within online auction system 100.

An auctioneer 118 may appreciate the applause but find it to be distracting, and therefore auctioneer 118 may be provided with a control option to mute applause. Applause may be automatically muted if auctioneer 118 selects to speak to the Participants.

Applause may be indicated additionally or alternatively to the sound of hands clapping together, by visually showing hands clapping together, or by displaying a lighted “APPLAUSE” sign or the like.

Another example of Participant feedback is ratings. After a Live Auction, Participants may be given the option to rate one or more of auctioneer 118, auction host 122, and the other Participants. As noted above, the rating and the Score are different: the Score is an objective mathematical evaluation and the rating is a subjective peer evaluation. Ratings may be input on a sliding scale, selected from a set, or entered into a field. For example, a Participant may be offered discrete options for submitting a rating of one (1) through five (5) wherein each of the ratings is described by some characteristic related to the auction. An auctioneer 118 rating of five could be described as “auction was organized and fun” and a rating of one as “auction was disorganized and/or boring”. As a further example, a Participant rating of five could be described as “participant contributed to the auction in a positive manner” and a rating of one as “participant was disruptive”.

The ratings submitted for a Participant are averaged to provide an auction rating for the Participant for the Live Auction just ended. The auction rating may then be, for example, weighted by multiplying the rating by the Bidder Factor or other factor and averaging the result with the Participant's cumulative user rating.

A Participant may also receive a separate auctioneer 118 rating and/or auction host 122 rating if applicable to the Live Auction. Auctioneer 118 and host 122 ratings may be averaged and weighted similarly to Participant ratings.

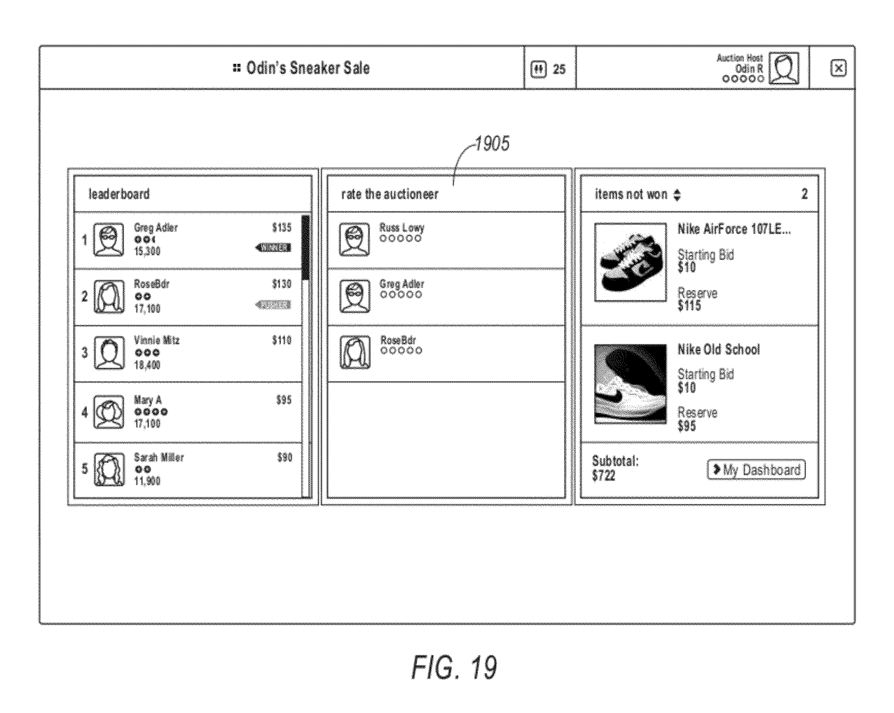

FIG. 19 illustrates an exemplary post-auction display, including an area 1905 for submitting ratings for the multiple auctioneers of the auction event just finished.

Ratings identify how each user of online auction system 100 is viewed by peers who attended auctions with the user. When a user first begins to use system 100, the user's rating may be skewed. Over time, however, a user's rating becomes more indicative of the user's peer approval rating. By looking at both the Score and the rating, an auction host 122 creating an auction may determine whether a user has an appropriate experience level and acceptable peer approval in determining whether to invite the user. Similarly, an invitee may look through the list of invitees who accepted invitations and determine if the experience level of the invitees is acceptable and if the invitees generally have high peer approval or low peer approval, to determine whether or not to join an auction. An invitee may look only at the Scores, selecting an auction to attend because, judging by the high Scores, the auction should be interesting. An invitee may look only at the ratings, preferring to avoid auctions that include multiple users with low ratings as it may be overly-competitive and not entertaining.

As can be appreciated by reading the foregoing descriptions of the auction from creation to Live Auction to rating, and later to fulfillment, an online auction system 100 may be quite expensive to implement and maintain.

### Monetization

To provide the auction service, and to further provide entertainment value by including components such as Monster Bid, Recoil, and Scoring in the auction, online auction system 100 must have a source of funding. In one exemplary implementation, online auction system 100 may sell advertisement space on the auction creation webpage, the auction home pages, and the Live Auction display. Advertisements, however, limit the useable space of a display and distract from the auction experience. In another exemplary implementation, the users of online auction system 100 may be charged a minimal fee to participate in various aspects of the auction, for example, ninety-nine cents (99¢) to create an auction or join an auction. In this way, users of the service pay for the service but the cost is low enough that it will not prevent users from creating and attending auctions. As discussed above, many components are included in system 100 to provide entertainment value in fun competition. Thus, for the example in which the cost is 99¢ to create an auction and 99¢ to join an auction, a group of four friends could create and participate in an auction for five dollars, providing a cheap evening of entertainment for the whole group.

### Accounting, Fulfillment and Reporting

Once an auction event is completed, the accounts of the Participants are tallied. There may be charges to auction host 122 for auction creation and charges to Participants for entry fees. Further, items won must be paid for. Payment for fees and items may be automatically deducted from an account or charged to an account. Alternatively, a user may be prompted to submit payment into online system 100. Accounting and payment are known in ecommerce applications.

When an item has been paid for, the seller is notified, for example via an email message or a message on a user account page. The seller must then package and send the item to the buyer. As discussed above, there may be multiple sellers, multiple items sold, and multiple buyers for one auction. Thus, unlike other online auctions that have one seller, one item sold, and one buyer, online auction system 100 must have the capability to provide communication between and monitor the interactions between the multiple buyers and multiple sellers, as well as provide status information to auction host 122 for all of the items sold in the auction. The system 100 must further have the capability to provide purchase and sale reports to buyers and sellers that have accounts in system 100, and the capability to provide auction reports to auction host 122.

### Mobile Applications

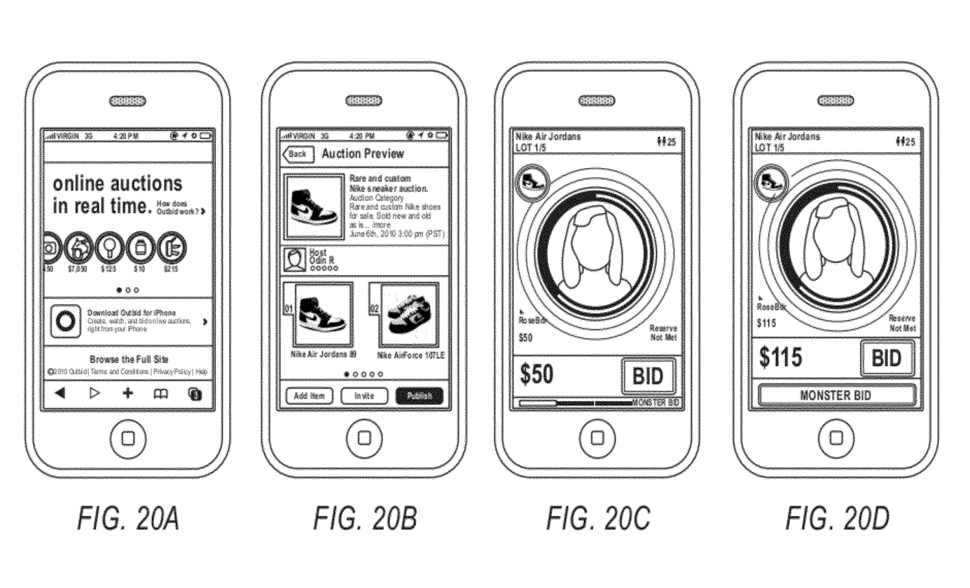

User access to online auction system 100 may be implemented on any terminal 112, 114, 116. For a terminal 112, 114, 116 with a smaller screen such as a handheld smart phone, the graphical user interface (GUI) must be adjusted to fit the screen while still being viewable to a reasonable degree. As such, the GUI must be modified for display on the smaller screen. Modifications may entail, for example, removing visual components from displays, combining options into scrollable lists, and using hiding screens which appear only when a user selection tool approaches a certain area on the display. Views from an exemplary GUI for a small screen are illustrated in FIGS. 20A-D. The underlying concepts for an online auction are as described above.

FIG. 20A illustrates an exemplary online auction system 100 auction application web page for small screen viewing. FIG. 20B illustrates an exemplary preview screen to preview an auction during the auction creation phase. FIG. 20C illustrates an exemplary display of a Live Auction after a live bid has been received. FIG. 20D illustrates an exemplary display of a Live Auction after a bidder 120 has earned the option to place a Monster Bid.

### CONCLUSION

The online auction system 100 may be implemented at least in part as computer-readable instructions (e.g., software) on one or more computing devices (e.g., servers, personal computers, etc.).

Computing devices generally include computer-executable instructions. In general, a processor (e.g., a microprocessor) receives instructions from a computer-readable medium and executes these instructions, thereby performing one or more processes, including one or more of the processes described herein. Such instructions and other data may be stored and transmitted using a variety of known computer-readable media.

A computer-readable medium (also referred to as a processor-readable medium) includes any tangible medium that participates in providing data (e.g., instructions) that may be read by a computer (e.g., by a processor of a computer). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. Instructions may be transmitted by one or more transmission media, including coaxial cables, copper wire and fiber optics, including the wires that comprise a system bus coupled to a processor of a computer. Transmission media may include or convey acoustic waves, light waves, and electromagnetic emissions, such as those generated during radio frequency (RF) and infrared (IR) data communications.

Computer-executable instructions may be compiled or interpreted from computer programs created using a variety of well-known programming languages and/or technologies, including, without limitation, and either alone or in combination, Java™, C, C++, Visual Basic, Java Script, Perl, PL/SQL, etc.

In general, computing systems and/or devices may employ any of a number of well-known computer operating systems, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Examples of computing devices include, without limitation, a computer workstation, a server, a desktop, notebook, laptop, or handheld computer, or some other known computing system and/or device.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain implementations, and should in no way be construed so as to limit the claimed invention.

Accordingly, it is to be understood that the above description is intended to be illustrative and not restrictive. Many implementations and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future implementations. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

Reference in the specification to “one example,” “an example,” “one approach,” “an application,” “an implementation” or similar language means that a particular feature, structure, or characteristic described in connection with the example is included in that example; however, multiple instances of such phrases does not necessarily refer to the same example.

Reference in the specification to “software” includes “firmware”, instructions built in to the hardware.

Nothing in this specification should be read to preclude an online auction system 100 implemented as a peer-to-peer application.

What is claimed is:

1. A system comprising:
a server running an application for controlling an online auction event; and
a scoring heuristic in communication with the application that generates scores based on user activity during the auction event;
wherein the scoring heuristic provides score information about each of a plurality of users participating in the auction event to the application during the auction event;
wherein the application provides the score information substantially simultaneously during the auction event to each of a plurality of computing devices in communication with the server over a network, for inclusion on a scoreboard display on a graphical user interface (GUI) of each computing device; and
wherein the scoring information includes a first score for each user participating in the auction event that represents points awarded during the auction of one item in the event and wherein the first score for a user is a separate from bid information regarding bids submitted by the user.

2. The system of claim 1, wherein the auction event includes auctions of a plurality of items and the scoring heuristic maintains a second score for each user participating in the auction event that represents cumulative points awarded during the auction event, and wherein the second score includes the first score.

3. The system of claim 2, wherein the scoring heuristic maintains a third score for each user participating in the auction event that represents an accumulation of points across a plurality of auction events, and wherein the third score is calculated by summing normalized scores from the plurality of auction events.

4. The system of claim 3, wherein the normalized scores are normalized using a predefined formula for adjusting participant points awarded in an auction event based on the number of participants in the auction event.

5. The system of claim 1, wherein user activity includes submitting a bid for the item being auctioned and the number of points awarded for the bid is dependent on how many bids were received previously within the auction of the one item.

6. The system of claim 5, wherein the number of points awarded is multiplied by a predefined number if the bid exceeds a current bid by more than a predefined increment.

7. The system of claim 1, wherein a user is awarded bonus points if the user was awarded more points in the auction of one item than were awarded to the winner of the one auctioned item.

8. The system of claim 1, wherein user activity includes joining the auction before auctioning begins on the first item and staying in the auction until after auctioning on the last item ends.

9. The system of claim 2, wherein a user is awarded bonus points for winning auctions on multiple items within the auction event.

10. The system of claim 1, wherein multiple bidders on an item in an online auction event are awarded points based on bidder activity during the item auction, a bid bucket includes a number of points equal to the combined number of points awarded to all bidders in the item auction, the points in the bid bucket are normalized according to the number of bidders in the item auction, and the normalized points are added to an auctioneer score and to an auction host score, wherein the auctioneer score and the auction host score are cumulative across a plurality of auction events.

11. A method, comprising:
conducting an online auction event including a plurality of auctions, comprising:
providing substantially simultaneously to a plurality of computing devices over a network display information for each computing device to use in presenting the auction event on a graphical user interface (GUI) to a user, wherein the display information includes information regarding a scoreboard to display; and
receiving user bid information from the plurality of computing devices;
awarding points to a user participating in the online auction event based on the user's activity in at least one of the plurality of auctions of the auction event;
maintaining a set of scores for each user participating in the auction event, the set of scores for a user including:
a first score of cumulative points awarded to the user in one auction in the plurality of auctions in the auction event;
a second score of cumulative points awarded to the user over the auction event; and
a third score of cumulative points awarded to the user over a plurality of auction events;
providing at least one score of the set of scores for at least one user to the plurality of computing devices for display on the scoreboard.

12. The method of claim 11, further comprising:
providing at least two scores of the set of scores for at least one user to the plurality of computing devices for display on the scoreboard.

13. The method of claim 11, further comprising:
calculating the sum of all points awarded in the auction event;
awarding the sum to an auction host of the auction event as an auction host score for the auction event;
providing the auction host score to the plurality of computing devices for display on the scoreboard.

14. The method of claim 11, further comprising:
receiving a plurality of user ratings of an auction host for the auction event from a plurality of computing devices;
calculating an average user rating for the auction host from the user ratings received;
providing the average user rating for the auction host to the plurality of computing devices for display on the scoreboard.

15. The method of claim 11, further comprising:
receiving a plurality of user ratings of an auctioneer of at least one item in the auction event from a plurality of computing devices;
calculating an average user rating for the auctioneer from the user ratings received;
providing the average user rating for the auctioneer to the plurality of computing devices for display on the scoreboard.

16. A method, comprising:
presenting on a network site for display on a graphical user interface a set of information about an auction event, the information including:
a description of a plurality of auctions in the auction event, wherein each auction is for at least one item;
identification of an auction host that defined the auction event and a cumulative score for the auction host, wherein the cumulative score of the auction host is a sum of auction event scores and each auction event score is a normalized value representing a number of points awarded to the auction host in a prior auction event hosted by the auction host;
a list of users that have indicated they will attend the auction event and a cumulative score for each user, wherein the cumulative score for a user is a sum of auction event scores and each auction event score is a normalized value representing a number of points awarded to the user in a prior auction event; and
an option to join the auction event; and
presenting substantially simultaneously to a plurality of computing devices over a network display information for each computing device to use in presenting the auction event on a graphical user interface (GUI) to a user that has selected the option to join the auction event, wherein the display information includes information regarding a scoreboard to display.

17. The method of claim 16, the auction event information further including:
identification of an auctioneer for the first item to be auctioned in the auction event and a cumulative score for the auctioneer, wherein the cumulative score of the auctioneer is a sum of auction event scores and each auction event score is a normalized value representing a number of points awarded to the auctioneer in a prior auction event in which the auctioneer auctioned at least one item.

18. The method of claim 16, the auction event information further including:
a user rating for the auction host, wherein the user rating of the auction host is an average of user ratings received after at least one prior auction event; and
a user rating of the auctioneer, wherein the user rating of the auctioneer is an average of user ratings received after at least one prior auction event.

19. A system comprising:
a server running an application for controlling an online auction event; and
a scoring heuristic in communication with the application that generates scores based on user activity during the auction event;
wherein the scoring heuristic provides score information about each of a plurality of users participating in the auction event to the application during the auction event;
wherein the application provides the score information substantially simultaneously during the auction event to each of a plurality of computing devices in communication with the server over a network, for inclusion on a scoreboard display on a graphical user interface (GUI) of each computing device;
wherein the scoring information includes a first score for each user participating in the auction event that represents points awarded during the auction of one item in the event and wherein the first score for a user is a separate from bid information regarding bids submitted by the user; and
wherein the auction event includes auctions of a plurality of items and the scoring heuristic maintains a second score for each user participating in the auction event that represents cumulative points awarded during the auction event, and wherein the second score includes the first score.

20. The system of claim 19, wherein multiple bidders on an item in an online auction event are awarded points based on bidder activity during the item auction, a bid bucket includes a number of points equal to the combined number of points awarded to all bidders in the item auction, the points in the bid bucket are normalized according to the number of bidders in the item auction, and the normalized points are added to an auctioneer score and to an auction host score, and wherein the auctioneer score and the auction host score are cumulative across a plurality of auction events.
